(19) United States
(12) Patent Application Publication
(10) Pub. No.: US 2026/0189687 A1
(43) Pub. Date: Jul. 2, 2026

(54) SEMICONDUCTOR DEVICE, IMAGING SYSTEM, AND MOVABLE OBJECT

(71) Applicant: CANON KABUSHIKI KAISHA, Tokyo (JP)

(72) Inventor: EIKI AOYAMA, Chiba (JP)

(21) Appl. No.: 19/430,570

(22) Filed: Dec. 23, 2025

(30) Foreign Application Priority Data
Dec. 27, 2024 (JP) 2024-231627
Sep. 26, 2025 (JP) 2025-160284

(51) Int. Cl. H04N 17/00; H04N 23/667; H04N 25/773

(52) U.S. Cl. CPC H04N 17/002; H04N 23/667; H04N 25/773

(57) ABSTRACT

A semiconductor device comprising: a pixel unit including a converter that converts a pixel signal into a conversion signal and a hold unit that holds the conversion signal; a drive unit that generates a drive signal that indicates whether to cause the hold unit to hold the conversion signal; and a test unit that generates a test signal used for testing the hold unit, wherein, in a first operation mode, the drive unit outputs the drive signal to the pixel unit via a connecting line connected to the pixel unit, and the hold unit holds and outputs the conversion signal based on the drive signal, and wherein, in a second operation mode, the test unit outputs the test signal to the pixel unit via the connecting line, and the hold unit holds and outputs the test signal.

### BACKGROUND

### Field of the Technology

The present disclosure relates to a semiconductor device, an imaging system, and a movable object.

### Description of the Related Art

Japanese Patent Laid-Open No. 2023-111734 discloses an optical element outputting a test signal to detect failure of a counter that counts photons entering a pixel unit.

However, according to Japanese Patent Laid-Open No. 2023-111734, an additional connecting line is required to detect failure of a counter.

### SUMMARY

The present disclosure is directed to a semiconductor device in which an increase in connecting lines arranged in a pixel unit for detecting failure of a counter is suppressed.

According to an aspect of the present disclosure, there is provided a semiconductor device comprising: a pixel unit including a converter that converts a pixel signal into a conversion signal and a hold unit that holds the conversion signal; a drive unit that generates a drive signal that indicates whether to cause the hold unit to hold the conversion signal; and a test unit that generates a test signal used for testing the hold unit, wherein, in a first operation mode, the drive unit outputs the drive signal to the pixel unit via a connecting line connected to the pixel unit, and the hold unit holds and outputs the conversion signal based on the drive signal, and wherein, in a second operation mode, the test unit outputs the test signal to the pixel unit via the connecting line, and the hold unit holds and outputs the test signal.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of a photoelectric conversion device according to a first embodiment.

FIG. 2 is a diagram illustrating an arrangement example of a sensor substrate in the first embodiment.

FIG. 3 is a diagram illustrating an arrangement example of a circuit substrate according to the first embodiment.

FIG. 4 is a circuit diagram of an avalanche photodiode (APD) and a pulse generation unit according to the first embodiment.

FIG. 5A is a diagram illustrating the relationship between the operation of the APD and an output signal in the first embodiment.

FIG. 5B is a diagram illustrating the relationship between the operation of the APD and an output signal in the first embodiment.

FIG. 5C is a diagram illustrating the relationship between the operation of the APD and an output signal in the first embodiment.

FIG. 6 is a block diagram illustrating the configuration of a semiconductor device according to the first embodiment.

FIG. 7 is a block diagram illustrating flows of signals in the semiconductor device according to the first embodiment.

FIG. 8 is a block diagram illustrating a configuration of a pixel unit and flows of signals between the pixel unit and peripheral units according to the first embodiment.

FIG. 9 is a block diagram illustrating flows of signals in the semiconductor device according to a second embodiment.

FIG. 10 is a block diagram illustrating a configuration of a pixel unit and flows of signals between the pixel unit and peripheral units according to the second embodiment.

FIG. 11 is a block diagram illustrating flows of signals in the semiconductor device according to a third embodiment.

FIG. 12 is a block diagram illustrating two pixel units included in the semiconductor device according to a fourth embodiment.

FIG. 13 is a block diagram illustrating flows of signals in the semiconductor device according to the fourth embodiment.

FIG. 14 is a block diagram illustrating flows of signals in the semiconductor device according to a fifth embodiment.

FIG. 15 is a block diagram illustrating two pixel units included in the semiconductor device according to a sixth embodiment.

FIG. 16 is a block diagram illustrating flows of signals in the semiconductor device according to the sixth embodiment.

FIG. 17 is a block diagram illustrating flows of signals in the semiconductor device according to a modified example of the sixth embodiment.

FIG. 18 is a block diagram illustrating flows of signals in the semiconductor device according to a seventh embodiment.

FIG. 19 is a block diagram illustrating flows of signals in the semiconductor device according to an eighth embodiment.

FIG. 20 is a block diagram of an imaging system according to a ninth embodiment.

FIG. 21 is a block diagram of a photodetection system according to a tenth embodiment.

FIG. 22 is a schematic diagram of an endoscope surgery system according to an eleventh embodiment.

FIG. 23A is a schematic diagram of a light detection system according to a twelfth embodiment.

FIG. 23B is a schematic diagram of a movable body according to the twelfth embodiment.

FIG. 23C is a schematic diagram of a movable body according to the twelfth embodiment.

FIG. 23D is a schematic diagram of a movable body according to the twelfth embodiment.

FIG. 24 is a flowchart illustrating an operation of the light detection system according to the twelfth embodiment.

FIG. 25A is a diagram illustrating a specific example of an electronic device according to a thirteenth embodiment.

FIG. 25B is a diagram illustrating a specific example of an electronic device according to the thirteenth embodiment.

### DESCRIPTION OF THE EMBODIMENTS

Embodiments of the present disclosure will be described below with reference to the accompanying drawings. The following embodiments are intended to embody the technical idea of the present disclosure and do not limit the present disclosure. The sizes and positional relationships of the members shown in the drawings may be exaggerated for clarity of explanation. In the following description, the same components are denoted by the same reference numerals, and description thereof may be omitted.

### First Embodiment

The semiconductor device according to the present embodiment comprises a circuit substrate including various circuits and connecting lines for signal processing. In addition, the semiconductor device according to the present embodiment comprises a sensor substrate electrically connected with the circuit substrate. The sensor substrate comprises a single-photon avalanche diode (hereafter referred to as “SPAD”) pixel including an avalanche photodiode (hereafter referred to as “APD”). The semiconductor device including the circuit substrate of the present embodiment can operate as a signal processing device for image data. Furthermore, the semiconductor device including the circuit substrate and the sensor substrate of the present embodiment can operate as a photoelectric conversion device.

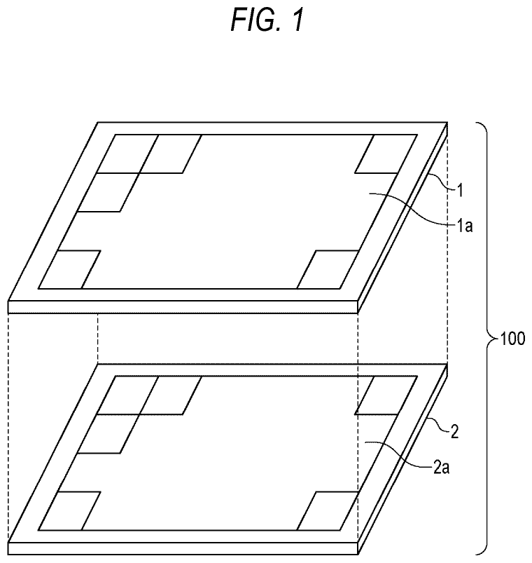

The configuration of the semiconductor device according to the present embodiment will be described with reference to FIGS. 1 to 4. FIG. 1 is a schematic diagram of a semiconductor device that can operate as a photoelectric conversion device according to the present embodiment, and shows a configuration of a stacked-type photoelectric conversion device 100. The photoelectric conversion device 100 includes a sensor substrate 1 and a circuit substrate 2 stacked on each other, and the sensor substrate 1 and the circuit substrate 2 are electrically connected to each other. The photoelectric conversion device according to the present embodiment is a back-illuminated photoelectric conversion device in which light is incident from a first surface of the sensor substrate 1 and the circuit substrate 2 is arranged on a second surface of the sensor substrate 1.

Hereinafter, the sensor substrate 1 and the circuit substrate 2 may be diced chips, but are not limited to chips. For example, each substrate may be a wafer. Further, each substrate may be diced after being laminated in a wafer state, or chips may be stacked and bonded after being formed into chips. The sensor substrate 1 is provided with a pixel region 1a, and the circuit substrate 2 is provided with a circuit region 2a for processing a signal detected by the pixel region 1a.

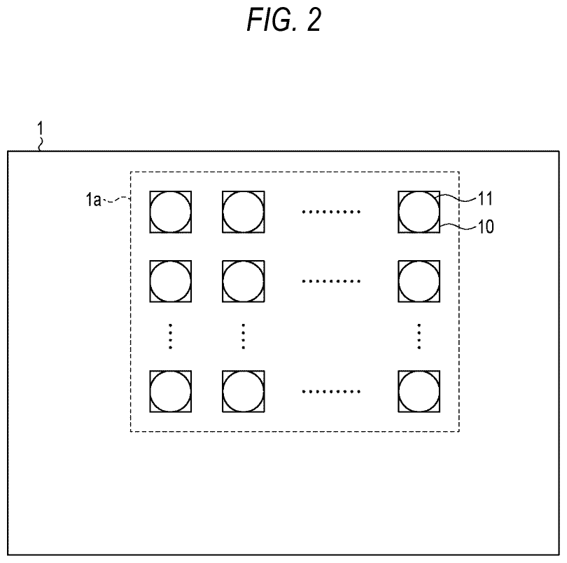

FIG. 2 is a diagram illustrating an arrangement example of the sensor substrate 1. Each of multiple pixels 10 includes an APD 11, and are arranged in a two-dimensional array in a plan view to form a pixel region 1a.

The pixel 10 is typically a pixel for forming an image, but in a case where the pixel 10 is used in a TOF (Time of Flight), the pixel 10 does not necessarily need to form an image. That is, the pixel 10 may be a pixel for measuring the arrival time and the amount of light.

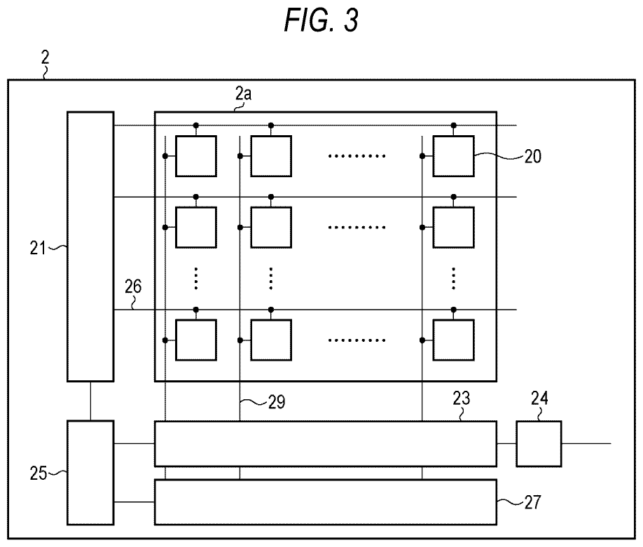

FIG. 3 is a diagram illustrating an arrangement example of the circuit substrate 2. The circuit substrate 2 includes a signal processing unit or circuit 20, a vertical scanning circuit 21, a readout circuit 23, a horizontal scanning circuit 27, an output calculation unit or circuit 24, a control pulse generation circuit 25, a scanning line 26, and a signal line 29. The circuit region 2a is arranged in a region overlapping the pixel region 1a in FIG. 2 in a plan view. Further, in the plan view in FIG. 2, the vertical scanning circuit 21, the readout circuit 23, the horizontal scanning circuit 27, the output calculation unit 24, and the control pulse generation circuit 25 are disposed to overlap with a region between the edge of the sensor substrate 1 and the edge of the pixel region 1a. That is, the sensor substrate 1 has a pixel region 1a and a non-pixel region arranged around the pixel region 1a, and the vertical scanning circuit 21, the readout circuit 23, the horizontal scanning circuit 27, the output calculation unit 24, and the control pulse generation circuit 25 are arranged in a region overlapping the non-pixel region in a plan view.

The signal processing units 20 are electrically connected to the pixels 10 through connection wirings each provided for the pixel 10, and are arranged in a two-dimensional array in a plan view, similarly to the pixels 10. The signal processing unit 20 includes a photon counter that counts photons incident on the pixel 10. The photon counter may include a binary counter.

The vertical scanning circuit 21 receives a control pulse supplied from the control pulse generation circuit 25, and supplies the control pulse to the signal processing unit 20 corresponding to the pixels 10 in each row via the scanning line 26. The vertical scanning circuit 21 may include a logic circuit such as a shift register or an address decoder.

The readout circuit 23 acquires a pulse count value of a digital signal from the signal processing unit 20 of each row via the signal line 29. Then, an output signal is output to a signal processing circuit (signal processing device) outside the photoelectric conversion device 100 via the output calculation unit 24. The readout circuit 23 may have a function of a signal processing circuit for correcting the pulse count value or the like. The horizontal scanning circuit 27 receives the control pulse from the control pulse generation circuit 25, and sequentially outputs the pulse count value of each column in the readout circuit 23 to the output calculation unit 24. As described later, if the pulse count value exceeds a threshold value, the output calculation unit 24 estimates an actual image signal (pulse count value) based on the time count value included in additional information and the threshold value, and replaces (extrapolates) the pulse count value with the estimated pulse count value. On the other hand, if the pulse count value is equal to or smaller than the threshold value, the pulse count value is output as an image signal as it is.

The output calculation unit 24 performs a predetermined process on the pulse count value read by the readout circuit 23, and outputs an image signal to the outside. As will be described later, if the pulse count value exceeds the threshold value, the output calculation unit 24 can perform processing such as calculation of the pulse count value.

In FIG. 2, the arrangement of photoelectric conversion elements in the pixel region 1a may be one-dimensionally arranged. In addition, the effect of the present disclosure can be achieved even in a configuration in which one pixel 10 is provided, and a configuration in which one pixel 10 is provided can be included in the present disclosure. In the photoelectric conversion device having the multiple pixels 10, the effect of suppressing the circuit scale according to the present embodiment becomes more significant. It is not necessary to provide one signal processing unit 20 for every pixel 10. For example, one signal processing unit 20 may be shared by the multiple pixels 10 and signal processing may be sequentially performed.

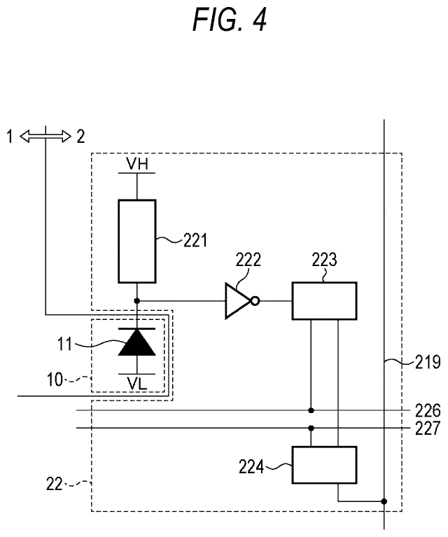

FIG. 4 is a block diagram of the APD and a pulse generation unit according to the present embodiment. FIG. 4 illustrates the pixels 10 of the sensor substrate 1 and a pulse generation unit 22 in the signal processing unit 20 of the circuit substrate 2. The APD 11 is disposed in the pixel 10. The pulse generation unit 22 includes a quenching element 221, a waveform shaping unit 222, a counter circuit 223, and a selection circuit 224.

The APD 11 generates charge pairs corresponding to incident light by photoelectric conversion. A voltage VL (first voltage) is supplied to an anode of the APD 11. A voltage VH (second voltage) higher than the voltage VL supplied to the anode is supplied to a cathode of the APD 11. A reverse bias voltage is applied to the anode and the cathode, and the APD 11 is in a state capable of avalanche multiplication. In a case where photons enter the APD 11 in a state where the reverse bias voltage is supplied, charges generated by the photons cause avalanche multiplication, and an avalanche current is generated.

The APD 11 can operate in a Geiger mode or a linear mode according to the voltage of the reverse bias. The Geiger mode is an operation in a state where the potential difference between the anode and the cathode is higher than the breakdown voltage, and the linear mode is an operation in a state where the potential difference between the anode and the cathode is near or lower than a breakdown voltage. An APD operating in the Geiger mode is particularly referred to as a SPAD or SPAD-type. As an example, the voltage VL (first voltage) may be −30 V and the voltage VH (second voltage) may be 1 V. The APD 11 may operate in a linear mode or a Geiger mode. In a case where the APD 11 operates as the SPAD, the potential difference becomes larger than that of the APD 11 in the linear mode, and the effect of the withstand voltage becomes significant. Accordingly, the SPAD may be used in this case.

The quenching element 221 is provided between the power supply line for supplying the voltage VH and the cathode of the APD 11. The quenching element 221 functions as a load circuit (quenching circuit) at the time of signal multiplication by avalanche multiplication, and has a function of suppressing a voltage supplied to the APD 11 and suppressing avalanche multiplication (quenching operation). Further, the quenching element 221 has a function of returning the voltage supplied to the APD 11 to the voltage VH by flowing a current corresponding to the voltage drop in the quenching operation (recharging operation).

The waveform shaping unit 222 functions as a signal generation unit that generates a detection pulse based on an output generated by incidence of a photon. That is, the waveform shaping unit 222 shapes the potential change of the cathode of the APD 11 obtained at the time of photon detection, and outputs a rectangular wave pulse signal (detection pulse). As the waveform shaping unit 222, for example, an inverter circuit is used. Although FIG. 4 shows an example in which one inverter is used as the waveform shaping unit 222, a circuit in which multiple inverters are connected in series may be used. Other circuits having a waveform shaping effect may also be used.

The counter circuit 223 counts the pulse signals output from the waveform shaping unit 222 and holds the count value. Further, a control pulse is supplied from the vertical scanning circuit 21 shown in FIG. 3 to the counter circuit 223 through a driving line 226 included in the scanning line 26. When the control pulse becomes active, the signal held in the counter circuit 223 is reset.

The selection circuit 224 includes a switch circuit, a buffer circuit for outputting a signal, and the like. The selection circuit 224 is supplied with a control pulse from the vertical scanning circuit 21 shown in FIG. 3 through a driving line 227. In accordance with the control pulse, the selection circuit 224 electrically switches a connected state or a non-connected state between the counter circuit 223 and a signal line 219.

A switch such as a transistor may be provided between the quenching element 221 and the APD 11, and between the APD 11 and the signal processing unit 20. Alternatively, the supply of the voltage VH or the voltage VL may be electrically switched by a switch such as a transistor.

As described above, the present embodiment uses the counter circuit 223. However, a time-to-digital converter (hereafter referred to as “TDC”) and a memory can be used instead of the counter circuit 223 to obtain timing of pulse detection. In this case, the generation timing of pulse signals output from the waveform shaping unit 222 is converted into digital signals by the TDC. For measuring the timing of pulse signals, a control pulse pREF (reference signal) is supplied from the vertical scanning circuit 21 shown in FIG. 3 to the TDC via a drive line. The TDC uses the control pulse pREF as a reference, and obtains a signal as a digital signal in which input timings of signals output from each pixel via the waveform shaping unit 222 are considered as relative time.

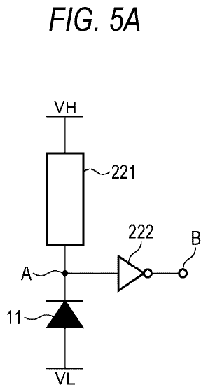

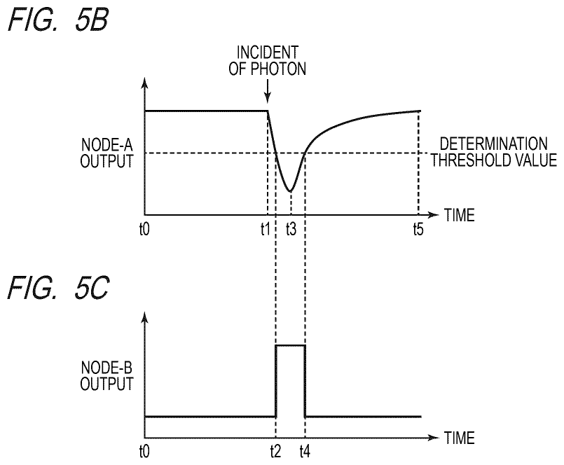

FIGS. 5A, 5B, and 5C are diagrams illustrating the relationship between the operation of the APD and the output signal in the present embodiment. FIG. 5A is a diagram extracted from the APD 11, the quenching element 221, and the waveform shaping unit 222 in FIG. 4. The input side and the output side of the waveform shaping unit 222 correspond to a node A and a node B shown in FIG. 5A, respectively. FIG. 5B illustrates a waveform change of node A and FIG. 5C illustrates a waveform change of node B.

In a period from time t0 to time t1, a reverse bias voltage of VH-VL is applied to the APD 11. When a photon is incident on the APD 11 at the time t1, avalanche multiplication occurs in the APD 11, an avalanche multiplication current flows in the quenching element 221, and the voltage of node A drops. When the voltage drop further increases and the potential difference applied to the APD 11 decreases, the avalanche multiplication of the APD 11 stops at time t3, and the voltage level of the node A does not drop by a certain constant value or more. After that, in a period from time t3 to time t5, a current that compensates a voltage drop from the voltage VL flows through the node A, and at the time t5, the node A is settled to the original voltage level. At this time, from time t2 to time t4, when the voltage level of the node A is lower than the threshold value of the waveform shaping unit 222, the node B becomes high-level. That is, the voltage waveform of node A is shaped by the waveform shaping unit 222, and a rectangular wave pulse signal is output from node B.

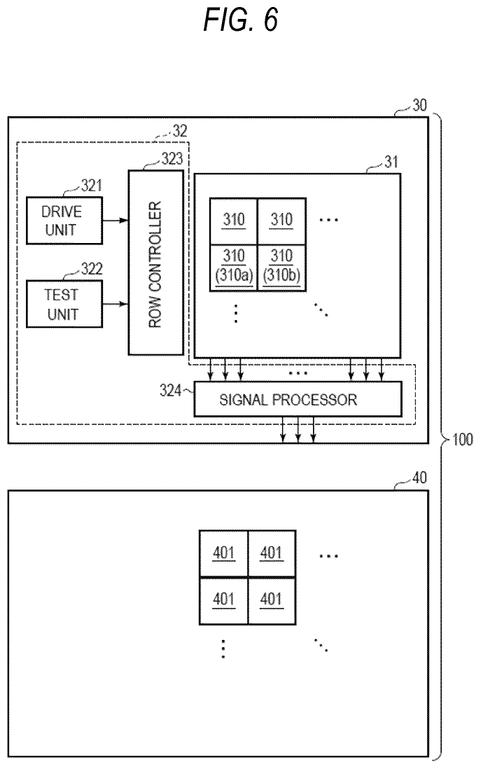

The configuration of the semiconductor device according to the present embodiment will be described in more detail with reference to FIGS. 6 to 8. FIG. 6 is a block diagram illustrating a configuration of the semiconductor device that operates as the photoelectric conversion device. The photoelectric conversion device 100 includes a signal processing substrate 30 and a light receiving substrate 40 stacked on the signal processing substrate 30. The semiconductor device according to the present disclosure may refer to the signal processing substrate 30 or the photoelectric conversion device in which the signal processing substrate 30 and the light receiving substrate 40 are stacked. The signal processing substrate 30 corresponds to the circuit substrate 2 of FIG. 1, and the light receiving substrate 40 corresponds to the sensor substrate 1 of FIG. 1. The signal processing substrate 30 includes a pixel region 31 and a peripheral region 32.

In the pixel region 31, multiple pixel units 310 are arranged in a matrix form. The pixel unit 310 includes a pixel unit 310a and a pixel unit 310b arranged to be adjacent to each other in the row direction. The pixel unit 310 holds an input signal. A detailed configuration of the pixel unit 310 will be described later.

In the peripheral region 32, a drive unit 321, a test unit 322, a row controller 323, and a signal processor 324 are arranged. The drive unit 321 supplies a drive signal to each pixel unit 310. The drive signal is transmitted in a case where the photoelectric conversion device 100 is operated as an imaging device (during an imaging operation). The test unit 322 supplies a test signal to each pixel unit 310. In addition, the test unit 322 supplies an expectation signal to the determining unit. The test signal and the expectation signal are transmitted in a case where the pixel unit 310 is tested (during a test operation). Specific configurations of the drive unit 321, the test unit 322, and the determining unit will be described later. The row controller 323 and a column control circuit (not shown) select the pixel unit 310 and input the drive signal or the test signal to the selected pixel unit 310. Further, the row controller 323 and the column control circuit cause the selected pixel unit 310 to output a signal held by the selected pixel unit 310 to the signal processor 324. The signal processor 324 receives a signal output from the pixel unit 310. The signal processor 324 performs predetermined processing on the input signal and outputs the processed signal to the outside of the signal processing substrate 30. Hereinafter, multiple units, circuits, and the like arranged in the peripheral region 32 are collectively referred to as peripheral units. The operation of the photoelectric conversion device 100 as an imaging device may be referred to as a first operation mode, and testing the pixel unit 310 may be referred to as a second operation mode.

The light receiving substrate 40 includes multiple photoelectric conversion elements 401 arranged in a matrix form. The photoelectric conversion element 401 generates an electrical signal in accordance with incidence of a photon, and outputs the generated electrical signal to the pixel unit 310. The photoelectric conversion element 401 in the present embodiment includes a single-photon avalanche diode (SPAD). The electrical signal generated by the photoelectric conversion element 401 corresponds to a pixel signal indicating the number of photons incident on the photoelectric conversion element 401.

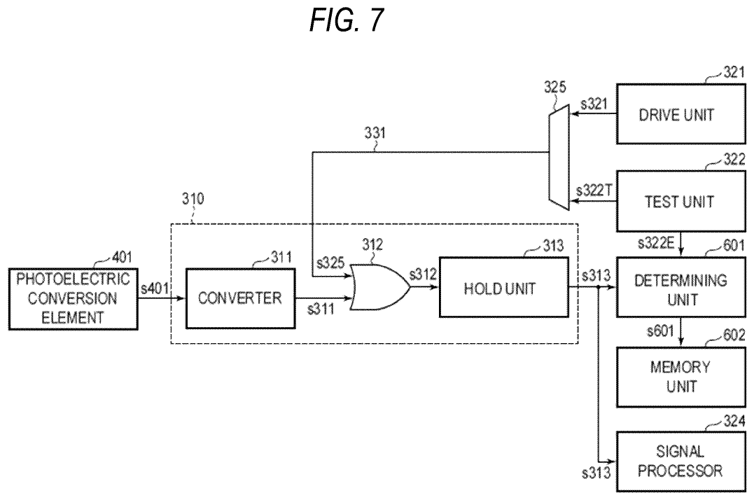

The operation of the photoelectric conversion device 100 operating as an imaging device will be described with reference to FIG. 7. FIG. 7 is a block diagram illustrating a flow of signals in the photoelectric conversion device 100 according to the present embodiment. FIG. 7 shows one pixel unit 310 among multiple pixel units arranged in a matrix form in the pixel region 31. The pixel unit 310 includes a converter 311, a selection unit (selector) 312, and a hold unit 313.

During the imaging operation, the converter 311 receives a pixel signal s401 from the photoelectric conversion element 401. The converter 311 converts the pixel signal s401 into a conversion signal s311 having a pulse shape. The converter 311 is connected to the selection unit 312. The converter 311 outputs the conversion signal s311 to the selection unit 312.

The selection unit 312 is a logical sum (OR) circuit. The selection unit 312 receives the conversion signal s311 from the converter 311. During the imaging operation, the selection unit 312 receives a low-level drive signal s321 as a selection signal s325 described later. The selection unit 312 is connected to the hold unit 313. The selection unit 312 outputs the conversion signal s311 to the hold unit 313 as a selection signal s312 based on the low-level drive signal s321.

The hold unit 313 holds the selection signal s312 corresponding to the conversion signal s311 received from the selection unit 312. Specifically, the hold unit 313 includes a counter that counts the conversion signal s311. The counter of the hold unit 313 counts the number of pulses included in the selection signal s312 (i.e., the conversion signal s311). The number of pulses corresponds to the number of photons having entered the photoelectric conversion element 401. The hold unit 313 holds the number of counted pulses as a hold signal s313. The hold unit 313 outputs the hold signal s313 to the signal processor 324. The signal processor 324 performs predetermined processing such as correction of imaging data and data compression on the hold signal s313. The number of signal lines for outputting the hold signal s313 to the signal processor 324 may vary depending on the number of bits or other characteristics of the signal held in the hold unit 313.

A selection unit 325 (switch unit) is disposed in the peripheral region 32. The selection unit 325 selectively connects a common connecting line 331 to the drive unit 321 or the test unit 322 in accordance with a control signal from the test unit 322. The selection unit 325 selectively outputs the drive signal s321 or a test signal s322T as the selection signal s325 to the selection unit 312 via the common connecting line 331. The selection unit 325 is connected to the drive unit 321 and the test unit 322. The selection unit 325 receives the drive signal s321 from the drive unit 321. The selection unit 325 receives the test signal s322T from the test unit 322. During the imaging operation, the selection unit 325 connects the common connecting line 331 to the drive unit 321 in accordance with the control signal from the test unit 322. The selection unit 325 outputs the selected drive signal s321 to the selection unit 312 as the selection signal s325 via the common connecting line 331. The control signal input to the selection unit 325 may be supplied by a control unit different from the test unit 322.

During the imaging operation, the drive signal s321 with a high-level is input to the selection unit 312 as the selection signal s325, whereby the operation of the hold unit 313 can be stopped. That is, since the selection unit 312 continues to output the high-level selection signal s312 to the hold unit 313 based on the high-level drive signal s321, the hold unit 313 does not perform a count operation. For example, the power consumption of the photoelectric conversion device 100 can be reduced by stopping, based on the drive signal s321, the count operation of the hold unit 313 of the pixel unit 310 arranged in the specific region in which the imaging operation is not performed. The drive signal s321 corresponds to a control signal that instructs the pixel unit 310 whether to cause the hold unit 313 to hold the conversion signal s311 output from the converter 311 during the imaging operation.

The operation of the photoelectric conversion device 100 when testing the hold unit 313 will be described with reference to FIG. 7. Hereinafter, testing the hold unit 313 is referred to as the test operation.

During the test operation, the converter 311 receives the pixel signal s401 with a high-level from the photoelectric conversion element 401. The pixel signal s401 is fixed to the high-level during the test operation. The pixel signal s401 during the test operation will be described later. The converter 311 converts the pixel signal s401 into the conversion signal s311. The conversion signal s311 is fixed to the low-level during the test operation. The converter 311 outputs the low-level conversion signal s311 to the selection unit 312.

During the test operation, the selection unit 325 connects the common connecting line 331 to the test unit 322 in accordance with the control signal from the test unit 322. The selection unit 325 selects the test signal s322T as the selection signal s325. The selection unit 325 outputs the test signal s322T to the selection unit 312 as the selection signal s325 via the common connecting line 331. The test signal s322T has a pulse shape. The control signal input to the selection unit 325 may be supplied by a control unit different from the test unit 322.

During the test operation, the conversion signal s311 with a low-level is supplied for the selection unit 312. Therefore, the selection unit 312 outputs the test signal s322T received from the test unit 322 via the common connecting line 331 to the hold unit 313 as the selection signal s312.

The hold unit 313 holds the selection signal s312 corresponding to the test signal s322T received from the selection unit 312. The hold unit 313 counts the number of pulses included in the selection signal s312 (i.e., the test signal s322T). The number of pulses corresponds to the value indicated by an expectation signal s322E output from the test unit 322 to a determining unit 601. The hold unit 313 holds the number of counted pulses as the hold signal s313. The hold unit 313 outputs the hold signal s313 to the determining unit 601.

The determining unit 601 receives the hold signal s313 corresponding to the number of pulses of the test signal s322T from the hold unit 313. Further, the determining unit 601 receives the expectation signal s322E from the test unit 322. The determining unit 601 compares the hold signal s313 with the expectation signal s322E. If the hold signal s313 and the expectation signal s322E indicate the same value, the determining unit 601 determines that the hold unit 313 is operating normally. If the hold signal s313 and the expectation signal s322E indicate different values from each other, the determining unit 601 determines that the hold unit 313 is not operating normally or the hold unit 313 has a failure. The determining unit 601 determines the operation of the hold unit 313 for each of the pixel units 310 arranged in the pixel region 31. The determining unit 601 outputs a determination signal s601 indicating the result of the determination for each of the pixel units 310 to a memory unit 602. The memory unit 602 stores the determination result of each of the pixel units 310 in association with the coordinates of the corresponding pixel unit 310. The hold signal s313 output from the pixel unit 310 that is not operating normally during the imaging operation is corrected by the signal processor 324 based on the determination result stored in the memory unit 602. The determining unit 601 and the memory unit 602 may be disposed in the peripheral region 32, or may be disposed outside the photoelectric conversion device 100.

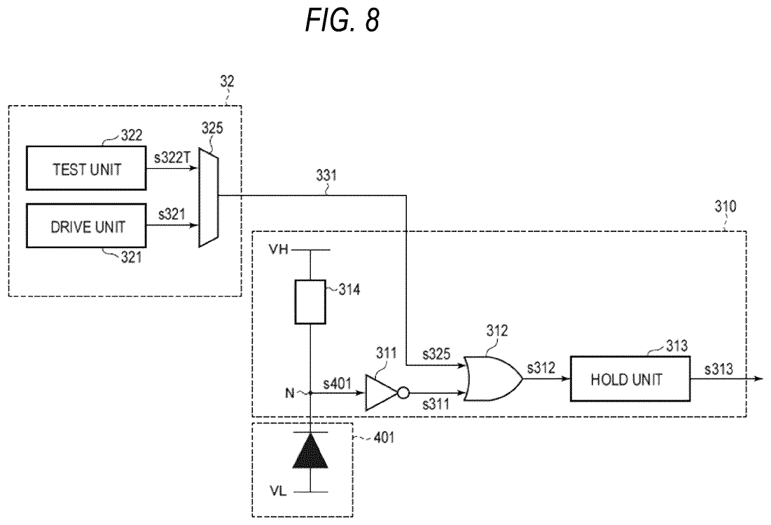

The operation of the pixel unit 310 during the imaging operation and the test operation is described with reference to FIG. 8. FIG. 8 is a block diagram illustrating a circuit configuration of the pixel unit 310 and a flow of signals between the pixel unit 310 and the peripheral units according to the first embodiment.

The photoelectric conversion element 401 includes a SPAD. The pixel unit 310 includes the converter 311, the selection unit 312, the hold unit 313, and a quench element 314. The converter 311 in the present embodiment is a NOT circuit (gate circuit). The converter 311 generates the conversion signal s311 by inverting the voltage level of a node N connected to the cathode of the photoelectric conversion element 401. The converter 311 is connected to the selection unit 312. The converter 311 outputs the generated conversion signal s311 to the selection unit 312. The converter 311 is connected to, via the node N, the quench element 314 and the cathode of the photoelectric conversion element 401. The voltage VH is applied to the quench element 314. The voltage VL lower than the voltage VH is applied to the anode of the photoelectric conversion element 401.

Hereinafter, the operation of the photoelectric conversion device 100 according to the present embodiment during the imaging operation will be described. The selection unit 325 selects the drive signal s321 generated by the drive unit 321. The selection unit 325 outputs the selected drive signal s321 to the selection unit 312 as the selection signal s325 via the common connecting line 331. The selection unit 312 receives the low-level drive signal s321 as the selection signal s325.

The converter 311 receives the pixel signal s401 generated according to the number of incident photons from the photoelectric conversion element 401. The converter 311 generates the conversion signal s311 by inverting the voltage level of the pixel signal s401. The converter 311 outputs the generated conversion signal s311 to the selection unit 312.

The selection unit 312 receives the selection signal s325 and the conversion signal s311 corresponding to the low-level drive signal s321. The selection unit 312 outputs the conversion signal s311 to the hold unit 313 as the selection signal s312 based on the low-level drive signal s321. The hold unit 313 receives the conversion signal s311 corresponding to the pixel signal s401 as the selection signal s312. The hold unit 313 counts photons having entered the photoelectric conversion element 401 based on the conversion signal s311, and holds the number of photons counted. The hold unit 313 outputs the hold signal s313 corresponding to the number of photons counted to the signal processor 324.

Hereinafter, the operation of the photoelectric conversion device 100 according to the present embodiment during the test operation will be described. The selection unit 325 selects the test signal s322T generated by the test unit 322. The selection unit 312 is connected to the peripheral units via the common connecting line 331. The selection unit 325 outputs the selected test signal s322T to the selection unit 312 as the selection signal s325 via the common connecting line 331.

The selection unit 312 receives the selection signal s325 corresponding to the test signal s322T and the conversion signal s311 fixed to the low-level. At the time of manufacturing the photoelectric conversion device 100, before the signal processing substrate 30 as the semiconductor device is electrically connected to the light receiving substrate 40, the photoelectric conversion element 401 is not electrically connected to the node N. That is, the signal processing substrate 30 as the semiconductor device does not include the photoelectric conversion element 401, and the voltage signal of the node N is fixed to the high-level. The voltage signal fixed to the high-level is converted into the conversion signal s311 fixed to the low-level by the converter 311. The converter 311 outputs the conversion signal s311 fixed to the low-level to the selection unit 312. The selection unit 312 outputs, as the selection signal s312, the selection signal s325 corresponding to the test signal s322T based on the low-level conversion signal s311 to the hold unit 313. The hold unit 313 holds the selection signal s325 output from the selection unit 312 as the hold signal s313. The hold unit 313 outputs the hold signal s313 corresponding to the test signal s322T to the determining unit 601. The determining unit 601 determines whether the hold unit 313 is operating normally based on the hold signal s313 and the expectation signal s322E.

After the signal processing substrate 30 is electrically connected to the light receiving substrate 40, for example, the photoelectric conversion element 401 is shielded to form a state in which photons do not enter the photoelectric conversion element 401. In the shielded state, the photoelectric conversion element 401 does not perform avalanche multiplication. Thus, the voltage signal of the node N is maintained at the high-level, and the conversion signal s311 is fixed to the low-level. That is, even after the signal processing substrate 30 and the light receiving substrate 40 are electrically connected to each other, it is possible to test the hold unit 313 based on the test signal s322T and the expectation signal s322E by forming the shielding state with respect to the photoelectric conversion element 401.

In the imaging device, a hold unit (counter) for counting incident photons and holding the counted number is provided for each pixel unit. If the counter is not operating normally, the number of photons having entered the photoelectric conversion element cannot be correctly held. Therefore, the pixel unit including the counter that is not normally operating cannot output an accurate signal. Thus, a configuration for detecting whether the counter is operating without failure is necessary to normally operate the photoelectric conversion device. In the related art, a connecting line for selecting a signal held in the counter and, the multiple connecting lines for transmitting the signal used for detecting a failure of the counter, are required for each pixel unit.

On the other hand, in order to realize miniaturization of pixels of the imaging device and high gradation of a captured image, it is required to reduce the arrangement area of the counter, and it is also required to increase the number of bits of the counter. In order to suppress an increase in the arrangement area while increasing the number of bits of the counter, it is necessary to reduce the number of connecting lines provided in each pixel unit for testing the counter.

According to the present embodiment, the control signal (drive signal) for causing the counter to hold the pixel signal from the photoelectric conversion element and the test signal for testing the counter are transmitted to each pixel unit using the common connecting line. Thus, the semiconductor device according to the present embodiment can suppress an increase in the number of connecting lines provided in each pixel unit for testing the counter, and can realize miniaturization of pixels of the imaging device and high gradation of the captured image.

### Second Embodiment

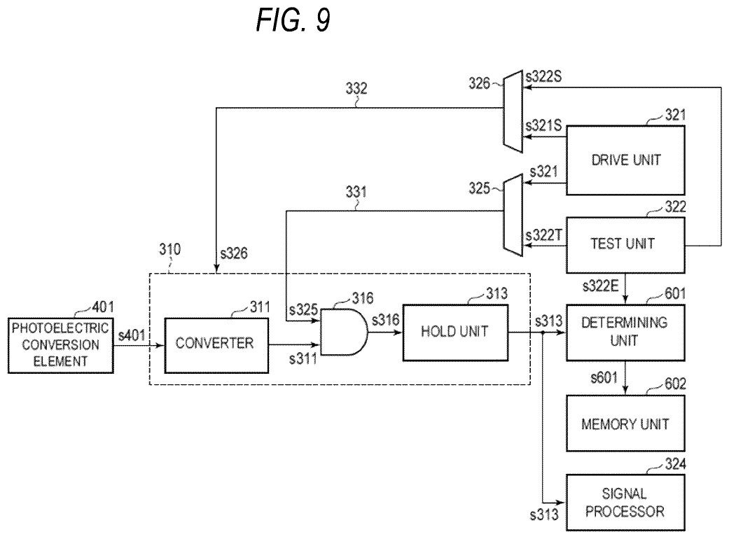

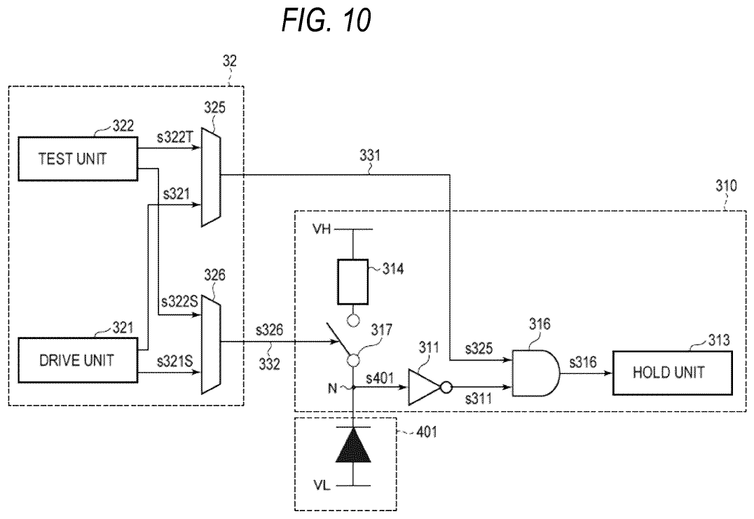

A semiconductor device that operates as a photoelectric conversion device according to a second embodiment of the present disclosure will be described with reference to FIGS. 9 and 10, focusing on differences from the first embodiment.

FIG. 9 is a block diagram illustrating a flow of signals in the photoelectric conversion device 100 according to the second embodiment. The photoelectric conversion device 100 according to the present embodiment is different from that of the first embodiment in that a selection signal s326 for fixing the conversion signal s311 to a constant level is input to the pixel unit 310.

The pixel unit 310 according to the present embodiment includes a selection unit 316. The selection unit 316 is a logical product or conjunction (AND) circuit. The selection unit 316 is connected to the converter 311, the selection unit 325, and the hold unit 313. The selection unit 316 receives the conversion signal s311 from the converter 311. Further, the selection unit 316 receives the selection signal s325 from the selection unit 325. The selection unit 316 selects the conversion signal s311 or the selection signal s325, and outputs the selected signal to the hold unit 313 as a selection signal s316.

During the imaging operation, the selection unit 316 receives the drive signal s321 with a high-level as the selection signal s325. Therefore, the selection unit 316 outputs the conversion signal s311 corresponding to the pixel signal s401 received from the converter 311 to the hold unit 313 as the selection signal s316.

A selection unit 326 is disposed in the peripheral region 32 in the present embodiment. The selection unit 326 selects one of the input signals and outputs the selected signal. The selection unit 326 is connected to the drive unit 321 and the test unit 322. The selection unit 326 receives a switch signal s321S from the drive unit 321. Further, the selection unit 326 receives a switch signal s322S from the test unit 322. The selection unit 326 selectively outputs the switch signal s321S or the switch signal s322S to the pixel unit 310 as the selection signal s326 through a common connecting line 332. Specifically, during the imaging operation, the selection unit 326 selects the switch signal s321S based on the control signal from the test unit 322. On the other hand, during the test operation, the selection unit 326 selects the switch signal s322S based on the control signal from the test unit 322. The switch signals s321S and s322S will be described later. The selection unit 326 outputs the selected switch signal s321S or the selected switch signal s322S to the pixel unit 310 as the selection signal s326 through the common connecting line 332. The control signal input to the selection unit 326 may be supplied by a control unit different from the test unit 322.

The operation of the pixel unit 310 during the imaging operation and the test operation will be described with reference to FIG. 10. FIG. 10 is a block diagram illustrating a configuration of the pixel unit 310 and a flow of signals between the pixel unit 310 and the peripheral units according to the second embodiment.

The pixel unit 310 according to the present exemplary embodiment includes the converter 311, the selection unit 316, the hold unit 313, the quench element 314, and a switch element 317. The selection unit 316 is connected to the converter 311 and the hold unit 313. The converter 311 is a NOT circuit (gate circuit). The selection unit 316 is connected to the selection unit 325 through the common connecting line 331.

The switch element 317 is provided between the quench element 314 and the photoelectric conversion element 401. The switch element 317 operates based on the selection signal s326 supplied from the selection unit 326. When the switch element 317 is closed, the photoelectric conversion element 401 and the quench element 314 are electrically connected to each other. That is, when the switch element 317 is closed, the voltage VH is applied to the photoelectric conversion element 401, and the photoelectric conversion element 401 is charged. On the other hand, when the switch element 317 is open, the voltage VH is not applied to the photoelectric conversion element 401, and the photoelectric conversion element 401 is not charged.

Hereinafter, the operation of the photoelectric conversion device 100 according to the present embodiment during the imaging operation will be described. The selection unit 325 selects the drive signal s321 generated by the drive unit 321. The selection unit 325 outputs the selected drive signal s321 to the selection unit 316 as the selection signal s325 via the common connecting line 331. The selection unit 316 receives the drive signal s321 with a high-level as the selection signal s325.

The selection unit 326 outputs the high-level switch signal s321S as the selection signal s326 via the common connecting line 332, and closes the switch element 317. By closing the switch element 317, the photoelectric conversion element 401 is recharged after avalanche multiplication. Therefore, the pixel signal s401 corresponding to the incidence of the photon on the photoelectric conversion element 401 is input to the converter 311. The conversion signal s311 corresponding to the pixel signal s401 is input to the selection unit 316. The selection unit 316 outputs the conversion signal s311 to the hold unit 313 as the selection signal s316 based on the selection signal s325 corresponding to the high-level drive signal s321.

The count operation of the hold unit 313 can be stopped by inputting the low-level drive signal s321 to the selection unit 316 as the selection signal s325. For example, it is possible to reduce the power consumption of the photoelectric conversion device 100 by stopping the count operation by the hold unit 313 of the pixel unit 310 arranged in the region where the imaging operation is not performed based on the drive signal s321. The switch can be opened by inputting the low-level drive signal s321 as the selection signal s326 to the switch element 317, and the recharging of the photoelectric conversion element 401 after the avalanche multiplication can be stopped. The recharging of the photoelectric conversion element 401 is stopped during a period in which the counting operation of incident photons is unnecessary, whereby power consumption of the pixel unit 310 can be reduced.

Hereinafter, the operation of the photoelectric conversion device 100 according to the present embodiment during the test operation will be described. The selection unit 325 selects the test signal s322T generated by the test unit 322. The selection unit 325 outputs the selected test signal s322T to the selection unit 316 as the selection signal s325 via the common connecting line 331. The selection unit 316 receives the test signal s322T as the selection signal s325.

The selection unit 326 outputs the switch signal s322S with a low-level as the selection signal s326 via the common connecting line 332, and opens the switch element 317. When the switch element 317 is opened, the photoelectric conversion element 401 is electrically disconnected from the quench element 314. Therefore, the voltage VH is not applied to the photoelectric conversion element 401, and charging the photoelectric conversion element 401 is stopped. As a result, the voltage signal at the node N becomes a low-level. Based on the low-level voltage signal at the node N, the conversion signal s311 with a high-level is input to the selection unit 316 via the converter 311. The selection unit 316 outputs the test signal s322T as the selection signal s316 to the hold unit 313 based on the high-level conversion signal s311.

According to the present embodiment, even after the signal processing substrate 30 is electrically connected to the light receiving substrate 40, the hold unit (counter) can be tested without shielding the photoelectric conversion element 401. The drive signal s321 for holding the signal from the photoelectric conversion element 401 in the counter and the test signal s322T for testing the counter are transmitted to the pixel unit 310 using the common connecting line 331. Further, both of the switch signals s321S and s322S for controlling the operation of the switch element 317 during the imaging operation and the test operation are transmitted via the common connecting line 332. Thus, in the semiconductor device according to this embodiment, an increase in the number of connecting lines provided in the pixel unit for testing the counter can be suppressed, and miniaturization of pixels of the imaging device and high gradation of the captured image can be realized.

### Third Embodiment

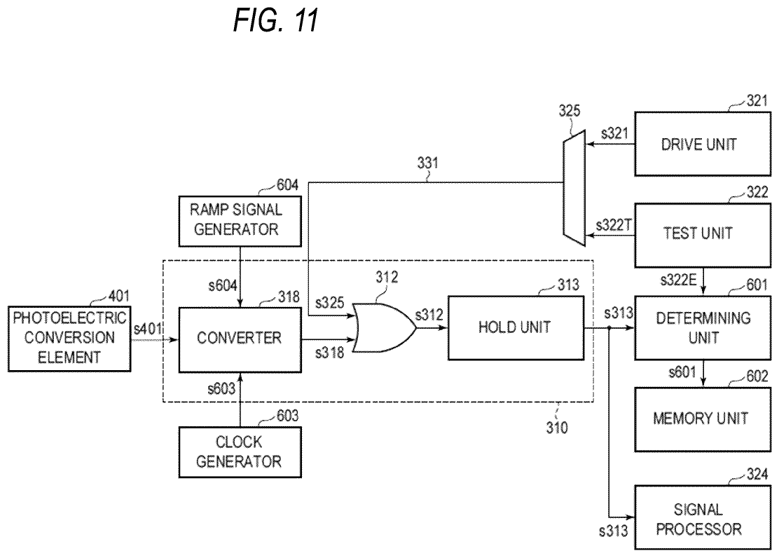

A semiconductor device that operates as a photoelectric conversion device according to a third embodiment of the present disclosure will be described with reference to FIG. 11, focusing on differences from the first embodiment.

FIG. 11 is a block diagram illustrating a flow of signals in the photoelectric conversion device 100 according to the third embodiment. The photoelectric conversion device 100 according to the present embodiment is different from that of the first embodiment in that the photoelectric conversion element 401 outputs an analog signal as a pixel signal and the pixel unit 310 converts the pixel signal into a digital signal.

The photoelectric conversion element 401 according to the present embodiment includes a photodiode. In a case where light enters the photodiode, a photovoltaic effect occurs in the photodiode according to the amount of incident light. The photoelectric conversion element 401 generates the pixel signal s401 indicating an analog value based on the photovoltaic effect. The photoelectric conversion element 401 outputs the generated pixel signal s401 to the pixel unit 310. The pixel unit 310 according to the present embodiment includes a converter 318. The converter 318 receives the pixel signal s401 generated by the photoelectric conversion element 401. The converter 318 converts the pixel signal s401 indicating the analog value into the digital signal.

In the present embodiment, a clock generator 603 and a ramp signal generator 604 are disposed in the peripheral region 32. The clock generator 603 generates a clock signal s603 having a clock waveform. The clock generator 603 outputs the generated clock signal s603 to the converter 318. The ramp signal generator 604 generates a ramp signal s604. The ramp signal s604 has a ramp waveform in which the signal level linearly or almost linearly rises to a predetermined value in a predetermined period. The ramp signal generator 604 outputs the generated ramp signal s604 to the converter 318. The clock generator 603 and the ramp signal generator 604 may be disposed in a region other than the peripheral region 32.

The converter 318 includes a comparator and a logical product or conjunction (AND) circuit. During the imaging operation, the comparator receives the pixel signal s401 indicating the analog value from the photoelectric conversion element 401. Further, the comparator receives the ramp signal s604 from the ramp signal generator 604. The comparator compares the pixel signal s401 with the ramp signal s604. In a period in which the analog value indicated by the pixel signal s401 is higher than the signal level of the ramp signal s604, the comparator inputs a comparison signal with a high-level to the AND circuit of the converter 318. On the other hand, in a period in which the analog value indicated by the pixel signal s401 is equal to or lower than the signal level of the ramp signal s604, the comparator inputs a comparison signal with a low-level to the AND circuit of the converter 318. That is, the ramp signal s604 is used as a reference signal for evaluating the signal level of the pixel signal s401.

The AND circuit of the converter 318 receives the comparison signal from the comparator. The AND circuit of the converter 318 receives the clock signal s603 from the clock generator 603. The AND circuit of the converter 318 outputs the clock signal s603 to the selection unit 312 as a conversion signal s318 only in a period in which the comparison signal with a high-level is input. That is, the AND circuit of the converter 318 continues to output the clock signal s603 to the selection unit 312 until the magnitude correlation between the ramp signal s604 and the pixel signal s401 is reversed. On the other hand, the AND circuit of the converter 318 does not output the clock signal s603 to the selection unit 312 in the period in which the low-level comparison signal is input. That is, the AND circuit of the converter 318 does not output the clock signal s603 to the selection unit 312 after the signal level of the ramp signal s604 reaches the analog value indicated by the pixel signal s401. Since the signal level of the ramp signal s604 in a predetermined period rises linearly or almost linearly, the number of clocks of the clock signal s603 input to the selection unit 312 in the predetermined period changes according to the analog value of the pixel signal s401. As a result, the converter 318 outputs the clock signal having the number of clocks corresponding to the analog value of the pixel signal s401 to the selection unit 312 as the conversion signal s318. During the imaging operation, the selection unit 312 receives the low-level drive signal s321 from the drive unit 321 via the common connecting line 331 as the selection signal s325. The selection unit 312 selects the conversion signal s318 based on the low-level drive signal s321. The selection unit 312 outputs the selected conversion signal s318 to the hold unit 313 as the selection signal s312.

The hold unit 313 receives the selection signal s312 corresponding to the conversion signal s318 from the selection unit 312. The hold unit 313 counts the number of clocks included in the selection signal s312. The number of clocks included in the selection signal s312 corresponds to the analog value of the pixel signal s401. The hold unit 313 holds the counted number of clocks as a digital value corresponding to the pixel signal s401. The hold unit 313 outputs the digital value corresponding to the pixel signal s401 to the signal processor 324 as the hold signal s313. The count operation of the hold unit 313 can be stopped by inputting the high-level drive signal s321 from the drive unit 321 to the selection unit 312 through the common connecting line 331. For example, it is possible to reduce the power consumption of the photoelectric conversion device 100 by stopping the count operation of the hold unit 313 of the pixel unit 310 arranged in a specific region in which the imaging operation is not performed based on the drive signal s321.

During the test operation, the test unit 322 outputs the control signal to the clock generator 603 to cause the clock generator 603 to stop outputting the clock signal s603. In response to not receiving the input of the clock signal s603, the converter 318 generates the conversion signal s318 with a low-level. The converter 318 outputs the generated conversion signal s318 to the selection unit 312. In addition, the selection unit 325 outputs the test signal s322T to the selection unit 312 during the test operation. That is, during the test operation of the present embodiment, the selection unit 312 outputs the test signal s322T as the selection signal s312 to the hold unit 313 based on the low-level conversion signal s318. The hold unit 313 outputs the hold signal s313 corresponding to the test signal s322T to the determining unit 601. The determining unit 601 tests the hold unit 313 based on the hold signal s313 and the expectation signal s322E. The control signal input to the clock generator 603 may be supplied by a control unit different from the test unit 322.

According to the present embodiment, the converter 318 and the hold unit 313 are operated as an analog-to-digital (AD) converter. The drive signal s321 for holding the pixel signal s401 in the hold unit (counter) and the test signal s322T for testing the counter are transmitted to each pixel unit using the common connecting line 331. Thus, even in the case where the photoelectric conversion element 401 is used as a CMOS sensor or the like and includes a photodiode that generates the pixel signal in accordance with the photon, an increase in the number of connecting lines provided in each pixel unit for testing the counter can be suppressed, and miniaturization of pixels of the imaging device and high gradation of the captured image can be achieved. Further, even after the signal processing substrate 30 is electrically connected to the light receiving substrate 40, testing the hold unit 313 can be performed without shielding the photoelectric conversion element 401 by controlling the clock generator 603.

### Fourth Embodiment

A semiconductor device according to a fourth embodiment of the present disclosure will be described with reference to FIGS. 6, 12, and 13, focusing on differences from the first embodiment.

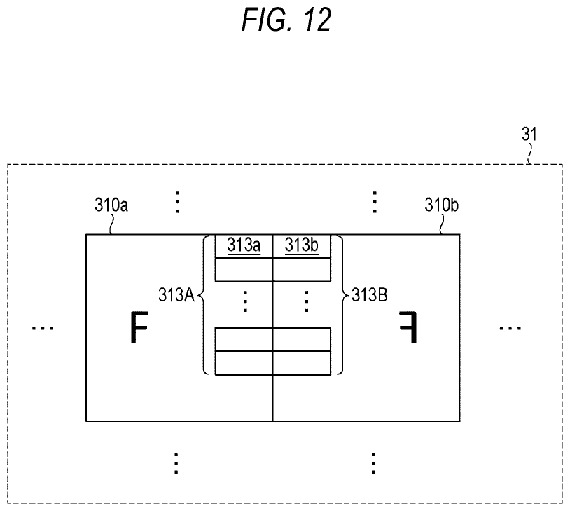

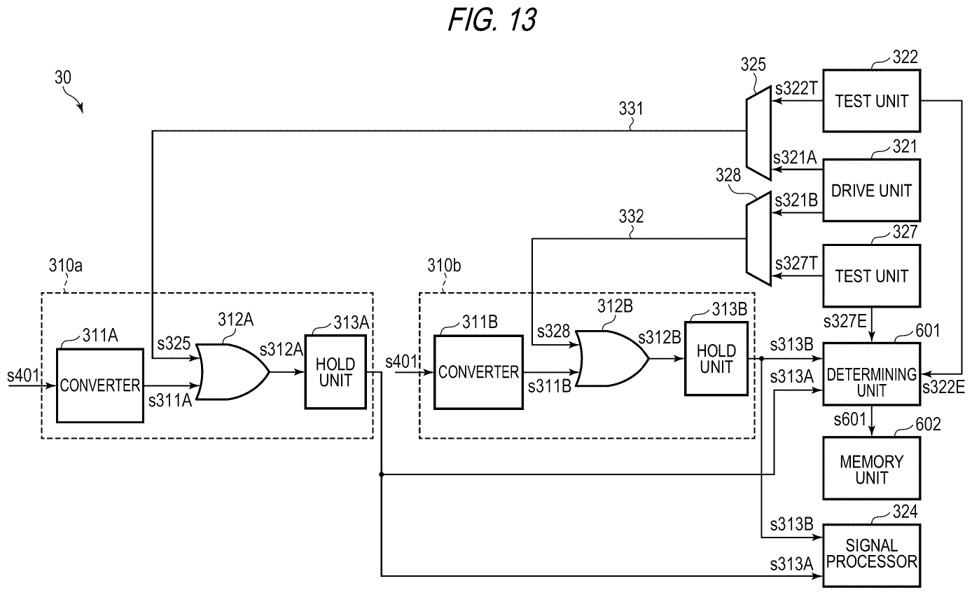

FIG. 12 is a block diagram illustrating two pixel units 310a and 310b in the signal processing substrate 30 that is the semiconductor device according to the present embodiment. FIG. 13 is a block diagram showing a flow of signals in the signal processing substrate 30 according to the present embodiment. The semiconductor device according to the present embodiment differs from the semiconductor device according to the first embodiment in that different test signals s322T and s327T are respectively transmitted to the pixel units 310a and 310b arranged in the same row.

As illustrated in FIG. 6, multiple pixel units 310 including pixel units 310a and 310b are arranged in a matrix form in the pixel region 31. As shown in FIGS. 6 and 12, the pixel units 310a and 310b are arranged to be adjacent to each other. A hold unit 313A of the pixel unit 310a (first pixel unit) includes multiple hold elements 313a. A hold unit 313B of the pixel unit 310b (second pixel unit) includes multiple hold elements 313b. The hold elements 313a and 313b are adjacent to each other and are arranged symmetrically with respect to the vertical axis in FIG. 12. The number of hold elements 313a and the number of hold elements 313b may vary depending on the number of bits of the signal held by the hold unit 313.

In the first embodiment, the common test signal s322T generated by the test unit 322 is transmitted by the row controller 323 to the pixel units 310a and 310b arranged in the same row. Therefore, the common test signal s322T is held in the hold unit 313A and the hold unit 313B. On the other hand, if a failure occurs such that the hold element 313a and the hold element 313b adjacent to each other are electrically short-circuited, common data can always be held in the hold element 313a and the hold element 313b. That is, if the common test signal s322T is transmitted to the pixel units 310a and 310b, a failure such as a short circuit between the hold element 313a and the hold element 313b cannot be detected. In order to detect a failure due to a short circuit or the like, it is necessary to transmit different test signals to the hold elements 313a and 313b.

As illustrated in FIG. 13, the pixel unit 310a includes a converter 311A, a selection unit 312A, and a hold unit 313A. The pixel unit 310b includes a converter 311B, a selection unit 312B, and a hold unit 313B. The converters 311A and 311B that output the conversion signals s311A and s311B correspond to the converter 311 of the first embodiment that outputs the conversion signal s311. The selection units 312A and 312B that output the selection signals s312A and s312B correspond to the selection unit 312 of the first embodiment that outputs the selection signal s312. The hold units 313A and 313B that output the hold signals s313A and s313B correspond to the hold unit 313 of the first embodiment that outputs the hold signal s313.

During the test operation, the selection unit 325 according to the present embodiment selects the test signal s322T (first test signal) as the selection signal s325 based on the control signal from the test unit 322 (first test unit), as in the first embodiment. The selection unit 325 transmits the selected test signal s322T to the pixel unit 310a through the common connecting line 331. The test signal s322T is held in the hold unit 313A via the selection unit 312A. The hold unit 313A transmits the held test signal s322T to the determining unit 601 as a hold signal s313A.

The signal processing substrate 30 according to the present embodiment further includes a test unit 327 (a second test unit) and a selection unit 328. The test unit 327 transmits a test signal s327T (second test signal) to the selection unit 328. The test signal s327T is, for example, a signal indicating a value different from that of the test signal s322T in each bit. In addition, the test unit 327 transmits an expectation signal s327E corresponding to the test signal s327T to the determining unit 601.

During the test operation, the selection unit 328 selects the test signal s327T as the selection signal s328 based on the control signal from the test unit 327. The selection unit 328 transmits the selected test signal s327T to the pixel unit 310b via the common connecting line 332. The test signal s327T is held in the hold unit 313B via the selection unit 312B. The hold unit 313B transmits the held test signal s327T to the determining unit 601 as the hold signal s313B.

The determining unit 601 determines whether the hold unit 313A is operating normally based on the hold signal s313A and the expectation signal s322E corresponding to the test signal s322T. Further, the determining unit 601 determines whether the hold unit 313B is operating normally based on the hold signal s313B and the expectation signal s327E corresponding to the test signal s327T. Further, the determining unit 601 compares the hold signal s313A and the hold signal s313B. For example, if the hold signal s313A and the hold signal s313B indicate the same value in a certain bit, the determining unit 601 determines that the hold elements 313a and 313b corresponding to the bit do not operate normally. On the other hand, if the hold signal s313A and the hold signal s313B indicate different values for all the bits, the determining unit 601 determines that all the hold elements 313a and 313b operate normally.

The drive unit 321 according to the present embodiment generates the drive signal s321A for the pixel unit 310a, and generates the drive signal s321B for the pixel unit 310b. During the imaging operation, the drive signal s321A is transmitted to the pixel unit 310a by the selection unit 325 via the common connecting line 331. The drive signal s321B is transmitted to the pixel unit 310b by the selection unit 328 through the common connecting line 332.

The test signals s322T and s327T and the expectation signals s322E and s327E may be generated by a common test unit. The control signal input to the selection unit 328 may be supplied by a control unit different from the test unit 327. Further, the determining unit 601 may be disposed outside the signal processing substrate 30.

According to the present embodiment, even if there is a problem such as a short circuit in the pixel units 310a and 310b arranged in the same row, a failure of the hold units 313A and 313B (counters) can be detected based on the test signals s322T and s327T indicating different values for each bit. The drive signals s321A and s321B for holding the pixel signal s401 in the counter and the test signals s322T and s327T for testing the counter are transmitted to the respective pixel units via the common connecting lines 331 and 332. Therefore, according to the present embodiment, it is possible to suppress an increase in the number of connecting lines provided in each pixel unit for testing the counter, and it is possible to realize miniaturization of the pixels of the imaging device and high gradation of the captured image.

### Fifth Embodiment

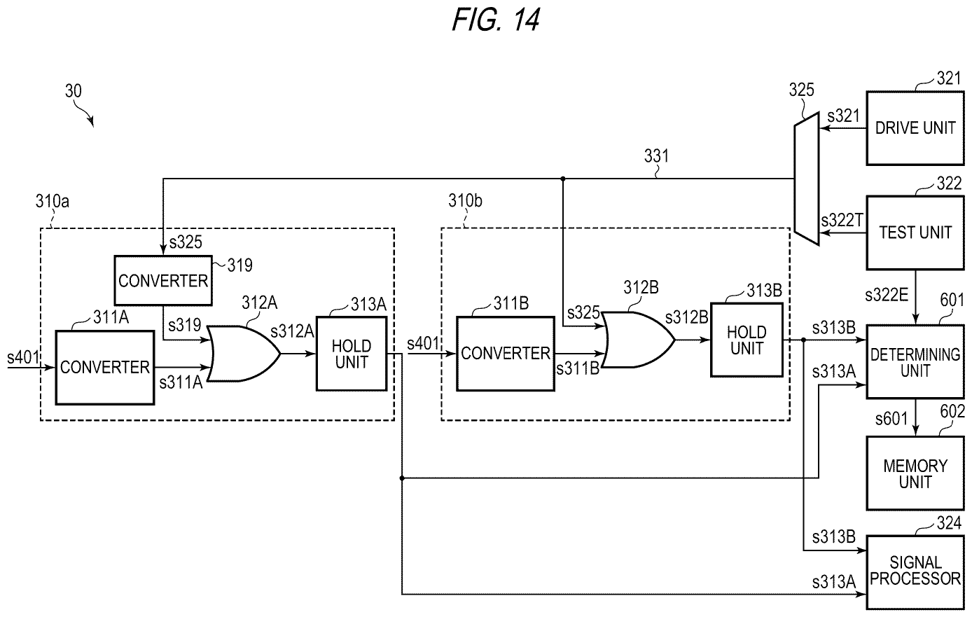

A semiconductor device according to a fifth embodiment of the present disclosure will be described with reference to FIG. 14, focusing on differences from the fourth embodiment.

FIG. 14 is a block diagram showing the flow of signals in the signal processing substrate 30 that is the semiconductor device according to the present embodiment. The semiconductor device according to the present embodiment is different from the fourth embodiment in that a common test signal s322T is transmitted to the pixel units 310a and 310b arranged in the same row.

The pixel unit 310a according to the present exemplary embodiment includes a converter 319. The converter 319 receives the selection signal s325 from the selection unit 325 via the common connecting line 331. During the test operation of the pixel unit 310a, the selection unit 325 transmits the test signal s322T to the converter 319 as the selection signal s325. The converter 319 determines that the selection signal s325 is a test signal based on the signal level or the like of the selection signal s325. The converter 319 inverts the polarity of the selection signal s325 determined to be the test signal. Specifically, the converter 319 generates a conversion test signal s322T′ (first conversion test signal) by inverting each bit value indicated by the test signal s322T. Each bit indicated by the conversion test signal s322T′ has a different value from the corresponding bit indicated by the test signal s322T. During the test operation, the converter 319 transmits the conversion test signal s322T′, which is the converted selection signal s325, to the selection unit 312A as the conversion signal s319. During the test operation, the selection unit 312A transmits the conversion test signal s322T′ to the hold unit 313A as the selection signal s312A. The conversion test signal s322T′ held by the hold unit 313A is transmitted to the determining unit 601 as the hold signal s313A.

On the other hand, the pixel unit 310b according to the present embodiment does not include the converter 319. Therefore, the test signal s322T transmitted to the pixel unit 310b during the test operation is input to the selection unit 312B via the common connecting line 331 without being subjected to the conversion processing. The selection unit 312B transmits the test signal s322T to the hold unit 313B as the selection signal s312B. The test signal s322T held by the hold unit 313B is transmitted to the determining unit 601 as the hold signal s313B. The hold signal s313B corresponding to the test signal s322T is not subjected to the conversion processing by the converter 319. Therefore, the hold signal s313B indicates a value different from that of the hold signal s313A corresponding to the conversion test signal s322T′ in each bit.

The determining unit 601 determines whether the hold unit 313A is operating normally based on the hold signal s313A and the expectation signal s322E. Specifically, the determining unit 601 generates an expectation signal s322E′ corresponding to the conversion test signal s322T′ based on the expectation signal s322E. For example, the determining unit 601 performs a process similar to the signal conversion process performed by the converter 319 on the expectation signal s322E. The determining unit 601 compares the hold signal s313A corresponding to the conversion test signal s322T′ with the expectation signal s322E′. If the hold signal s313A and the expectation signal s322E′ indicate the same value, the determining unit 601 determines that the hold unit 313A is operating normally. If the hold signal s313A and the expectation signal s322E′ indicate different values, the determining unit 601 determines that the hold unit 313A is not operating normally.

As in the first embodiment, the determining unit 601 determines whether the hold unit 313B is operating normally based on the hold signal s313B and the expectation signal s322E corresponding to the test signal s322T. Further, the determining unit 601 compares the hold signal s313A with the hold signal s313B. For example, if the hold signal s313A and the hold signal s313B indicate the same value in a certain bit, the determining unit 601 determines that the hold elements 313a and 313b corresponding to the bit have a failure. On the other hand, if the hold signal s313A and the hold signal s313B indicate different values in all bits, the determining unit 601 determines that the hold elements 313a and 313b operate normally. The determining unit 601 may be disposed outside the signal processing substrate 30.

On the other hand, during the imaging operation, the selection unit 325 transmits the drive signal s321 as the selection signal s325 for the pixel unit 310a to the converter 319 via the common connecting line 331. The converter 319 determines that the selection signal s325 is the drive signal based on the signal level or the like of the selection signal s325. The converter 319 does not perform conversion processing on the selection signal s325 determined to be the drive signal. The converter 319 at the time of the imaging operation transmits the drive signal s321, which is the selection signal s325 at the time of the imaging operation, to the selection unit 312.

According to the present embodiment, even if a problem such as a short circuit occurs in the pixel units 310a and 310b arranged in the same row, a failure of the hold units 313A and 313B (counters) can be detected using the common test signal s322T. The drive signal s321 for holding the pixel signal s401 in the counter and the test signal s322T for testing the counter are transmitted to each pixel unit using the common connecting line 331. Therefore, according to the present embodiment, it is possible to suppress an increase in the number of connecting lines provided in each pixel unit for testing the counter, and it is possible to realize miniaturization of the pixels of the imaging device and high gradation of the captured image.

### Sixth Embodiment

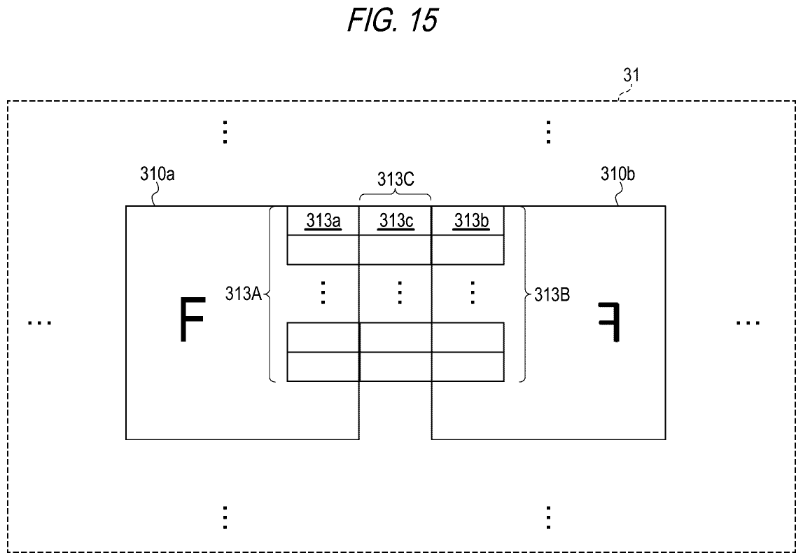

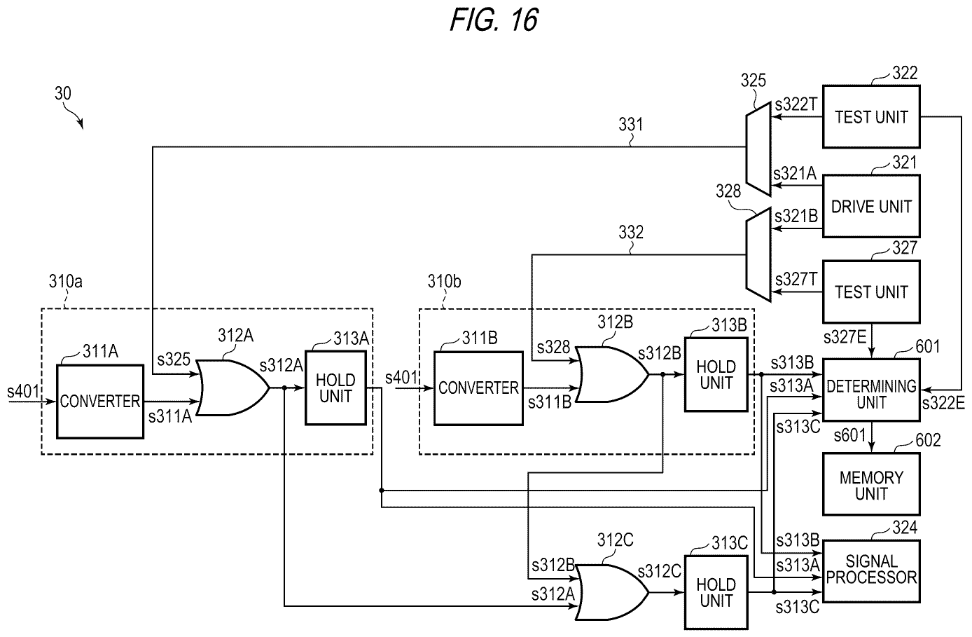

A semiconductor device according to a sixth embodiment of the present disclosure will be described with reference to FIGS. 15 and 16, focusing on differences from the fourth embodiment.

FIG. 15 is a block diagram illustrating two pixel units 310a and 310b in the signal processing substrate 30 that is the semiconductor device according to the present embodiment. FIG. 16 is a block diagram showing a flow of signals in the signal processing substrate 30 according to the present embodiment. The semiconductor device according to the present embodiment is different from that of the fourth embodiment in that the semiconductor device of the present embodiment further includes an addition unit 312C and a hold unit 313C.

As illustrated in FIG. 15, the hold unit 313C (third hold unit) is provided in the pixel region 31. The hold unit 313C holds the sum of the selection signal s312A and the selection signal s312B. That is, the hold unit 313C holds the sum of the output values of multiple pixel units. The hold unit 313C includes multiple hold elements 313c. The hold element 313c is arranged to correspond to the hold element 313a and the hold element 313b. The number of hold elements 313c can vary according to the number of bits of a signal held by the hold unit 313A (first hold unit) and the hold unit 313B (second hold unit). As illustrated in FIG. 15, the hold unit 313C may be arranged in a region between the hold unit 313A and the hold unit 313B. However, the position where the hold unit 313C is arranged is not limited to the region between the hold unit 313A and the hold unit 313B.

According to the present embodiment, three hold units 313A, 313B, and 313C are provided for two photoelectric conversion elements 401. The configuration according to the present embodiment can be used, for example, in a case where the photoelectric conversion device 100 performs autofocus using a difference of outputs between pixels arranged to be adjacent to each other. In a case where the photoelectric conversion device 100 performs autofocus, the selection signal s312A as the pixel signal s401 is held in the hold unit 313A, and the selection signal s312B as the pixel signal s401 is held in the hold unit 313B. On the other hand, in a case where the photoelectric conversion device 100 does not perform autofocus, the selection signals s312A and s312B as the pixel signal s401 are added together, and the added value is held in the hold unit 313C. Since the operation principle of autofocus is not directly related to the present disclosure, descriptions thereof are omitted. As another example, even if the photoelectric conversion device 100 has a binning function and output signals from the multiple photoelectric conversion elements 401 are summed and held in a single hold unit, the configuration according to the present embodiment can be used.

In the fourth embodiment, the hold unit 313A is tested using the test signal s322T generated by the test unit 322, and the hold unit 313B is tested using the test signal s327T generated by the test unit 327. For example, it is assumed that each of the hold units 313A and 313B holds three bits, the test signal s322T indicates “000”, and the test signal s327T indicates “111”. In this case, the hold unit 313C holds the value “111” that is the sum of the test signal s322T and the test signal s327T. Therefore, a common value “111” is held in the hold unit 313B and the hold unit 313C. On the other hand, for example, in a case where a failure such as an electrical short circuit occurs in the hold unit 313B and the hold unit 313C, a common value can be always held in the hold unit 313B and the hold unit 313C. That is, if common data is transmitted between the hold unit 313A and the hold unit 313C or between the hold unit 313B and the hold unit 313C, a failure such as a short circuit between the hold unit 313A and the hold unit 313C or between the hold unit 313B and the hold unit 313C cannot be detected. In order to detect a failure caused by a short circuit or the like, it is necessary to transmit different test signals to the hold units 313A, 313B, and 313C.

As illustrated in FIG. 16, the signal processing substrate 30 according to the present embodiment includes the addition unit 312C and a hold unit 313C. The addition unit 312C includes a logical OR circuit. During the imaging operation, the addition unit 312C receives the selection signal s312A as the conversion signal s311A from the selection unit 312A. During the imaging operation, the addition unit 312C receives the selection signal s312B as the conversion signal s311B from the selection unit 312B. The addition unit 312C adds the value indicated by the selection signal s312A (conversion signal s311A) and the value indicated by the selection signal s312B (conversion signal s311B). The addition unit 312C transmits a total signal s312C indicating a value obtained by adding the selection signal s312A and the selection signal s312B to the hold unit 313C. The hold unit 313C holds the total signal s312C received from the addition unit 312C. The hold unit 313C transmits the total signal s312C to the signal processor 324 and the determining unit 601 as a hold signal s313C.

During the test operation, the selection unit 325 according to the present embodiment transmits the test signal s322T to the pixel unit 310a via the common connecting line 331 as in the fourth embodiment. The test signal s322T is transmitted to the addition unit 312C and the hold unit 313A via the selection unit 312A. Similarly, the selection unit 328 according to the present embodiment transmits the test signal s327T to the pixel unit 310b through the common connecting line 332. The test signal s327T is transmitted to the addition unit 312C and the hold unit 313B via the selection unit 312B.

The test unit 322 and the test unit 327 according to the present embodiment output the test signal s322T and the test signal s327T while continuously changing values indicated by the test signal s322T and the test signal s327T. For example, if the hold units 313A, 313B, and 313C hold 3-bit data, the test unit 322 sequentially outputs signals indicating “010”, “101”, “000”, and “010” as the test signal s322T. On the other hand, the test unit 327 sequentially outputs signals indicating “101”, “010”, “000”, and “010” as the test signal s327T. In this example, the addition unit 312C adds the test signals s322T and s327T indicating the above-described values, and sequentially transmits signals indicating “111”, “111”, “000”, and “100” to the hold unit 313C as total signal s312C (total test signal). The hold unit 313C transmits the total signal s312C indicating “111”, “111”, “000”, and “100” to the sequential determining unit 601 as the hold signal s313C. On the other hand, the hold unit 313A transmits the test signal s322T (selection signal s312A) indicating “010”, “101”, “000”, and “010” to the sequential determining unit 601. In addition, the hold unit 313B transmits the test signal s327T (selection signal s312B) indicating “101”, “010”, “000”, and “010” to the determining unit 601. That is, the data indicated by the four hold signals s313C sequentially transmitted from the hold unit 313C to the determining unit 601 is different from the data indicated by the four hold signals s313A and S313B sequentially transmitted from the hold units 313A and 313B to the determining unit 601.

The determining unit 601 determines whether the hold unit 313A is operating normally based on the hold signal s313A and the expectation signal s322E corresponding to the test signal s322T. Further, the determining unit 601 determines whether the hold unit 313B is operating normally based on the hold signal s313B and the expectation signal s327E corresponding to the test signal s327T. Further, the determining unit 601 adds the expectation signal s322E and the expectation signal s327E to generate an expectation signal s313E. The determining unit 601 determines whether the hold unit 313C is operating normally based on the expectation signal s313E and the hold signal s313C. Further, the determining unit 601 compares the sequentially transmitted hold signals s313A and s313B with the sequentially transmitted hold signal s313C. For example, if the four sequentially transmitted hold signals s313B indicate the same data as the four sequentially transmitted hold signals s313C, the determining unit 601 determines that there is a failure due to a short circuit or the like between the hold signals s313B and s313C. On the other hand, if the four sequentially transmitted hold signals s313B indicate data different from the four sequentially transmitted hold signals s313C, the determining unit 601 determines that there is no failure due to a short circuit or the like between the hold unit 313B and the hold unit 313C.

According to the present embodiment, even if there is a problem such as a short circuit between the hold unit 313A and the hold unit 313C or between the hold unit 313B and the hold unit 313C, a failure generated between the hold unit 313A and the hold unit 313C or between the hold unit 313B and the hold unit 313C can be detected based on the test signals s322T and s327T and the hold signal s313C. For example, the data indicated by the test signals s322T and s327T may be adjusted to cause each of the hold elements 313c to hold a value different from the corresponding hold element 313a or 313b. That is, according to the present embodiment, it is possible to detect a failure caused by a short circuit or the like generated between the hold element 313c and the corresponding hold element 313a or 313b.

FIG. 17 shows a modification of the present embodiment. As shown in FIG. 17, a test unit 329 (third test unit) that generates a test signal s329T (third test signal) and an expectation signal s329E may be further provided. In the present modification, an OR circuit 314C is provided between the addition unit 312C and the hold unit 313C. During the test operation, the test unit 329 transmits the test signal s329T to the OR circuit 314C. The test unit 329 transmits the expectation signal s329E to the determining unit 601. The addition unit 312C transmits the total signal s312C (first total test signal) to the OR circuit 314C. The OR circuit 314C generates a total signal s314C (second total test signal) by adding the test signal s329T and the total signal s312C. The total signal s314C indicates data different from the hold signals s313A and s313B. The OR circuit 314C transmits the total signal s314C to the hold unit 313C. The hold unit 313C transmits the total signal s314C to the signal processor 324 and the determining unit 601 as the hold signal s313C. The determining unit 601 generates an expectation signal corresponding to the total signal s314C using the expectation signals s322E, s327E, and s329E. The determining unit 601 determines whether there is a failure generated between the hold unit 313A or 313B and the hold unit 313C based on the generated expectation signal and the expectation signals s322E, s327E. On the other hand, during the imaging operation, the test unit 329 transmits a control signal to the OR circuit 314C. The OR circuit 314C transmits the total signal s312C generated by adding the conversion signal s311A and the conversion signal s311B to the hold unit 313C as the total signal s314C based on the control signal. According to the modification of the present embodiment, it is possible to detect a failure generated between the hold unit 313A or 313B and the hold unit 313C based on the test signals s322T, s327T, and s329T.

### Seventh Embodiment

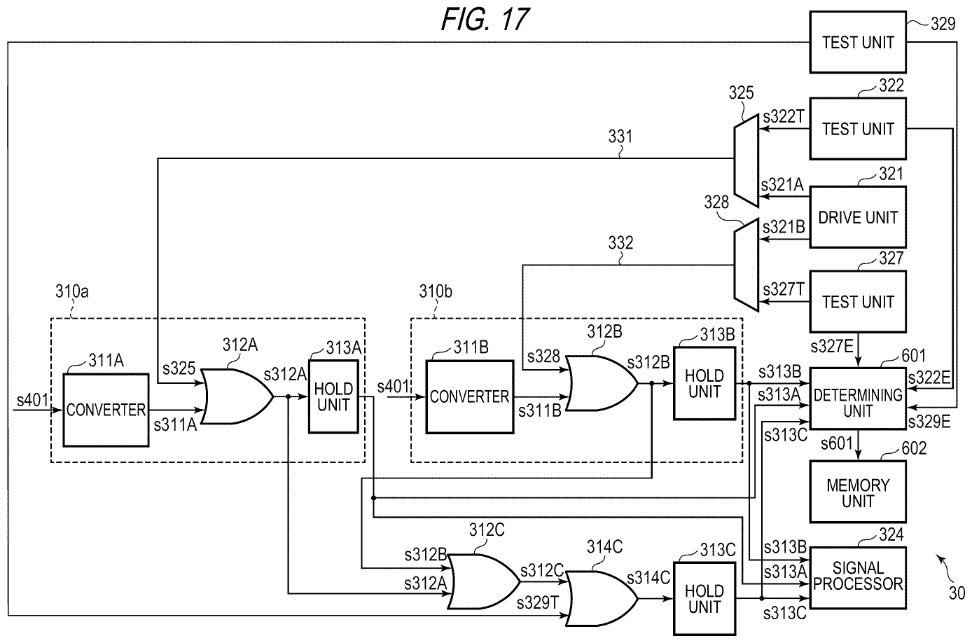

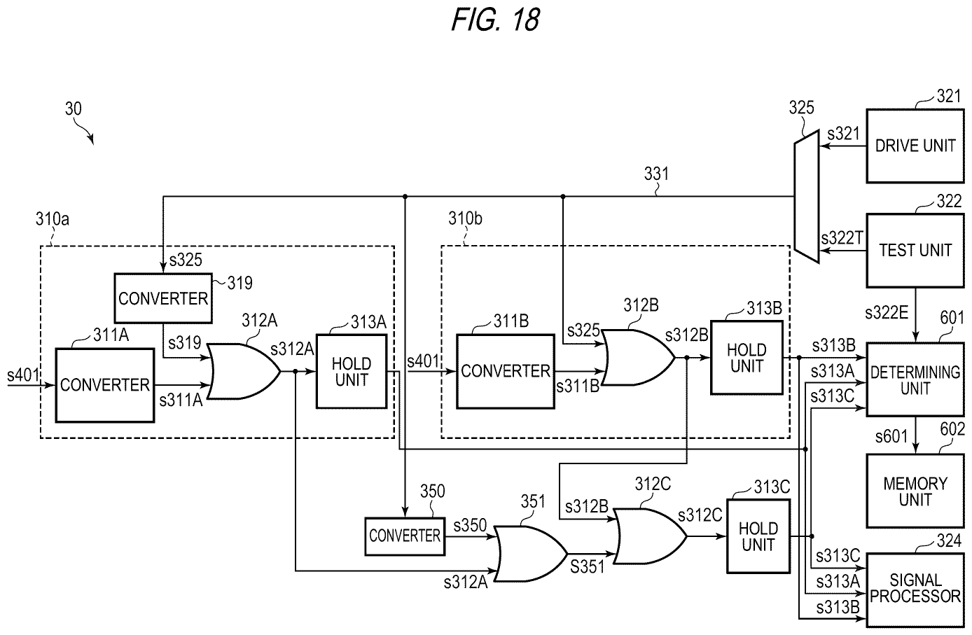

A semiconductor device according to a seventh embodiment of the present disclosure will be described with reference to FIG. 18, focusing on differences from the fifth embodiment.

FIG. 18 is a block diagram showing a flow of signals in the signal processing substrate 30 according to the present embodiment. The semiconductor device according to the present embodiment is different from that of the fifth embodiment in that the semiconductor device of the present embodiment further includes the addition unit 312C, the hold unit 313C, a converter 350, and an OR circuit 351. According to the present embodiment, as in the sixth embodiment, the signal output from the photoelectric conversion element 401 is held by multiple hold units.

As illustrated in FIG. 18, the signal processing substrate 30 according to the present embodiment includes the addition unit 312C, the hold unit 313C, a converter 350, and an OR circuit 351. During the test operation, the converter 350 receives the test signal s322T via the common connecting line 331. The converter 350 generates a conversion signal s350 (second conversion test signal) by inverting at least a part of the bit value indicated by the test signal s322T. The converter 350 transmits the generated conversion signal s350 to the OR circuit 351. The OR circuit 351 receives the conversion signal s350 from the converter 350. The OR circuit 351 receives the selection signal s312A (first conversion test signal s322T′) from the selection unit 312A. The OR circuit 351 generates a total signal s351 (third total test signal) by adding the conversion signal s350 and the selection signal s312A. The OR circuit 351 transmits the generated total signal s351 to the addition unit 312C.

The addition unit 312C receives the total signal s351 from the OR circuit 351. The addition unit 312C receives the selection signal s312B (test signal s322T) from the selection unit 312B. The addition unit 312C generates a total signal s312C (fourth total test signal) by adding the total signal s351 and the selection signal s312B. The data indicated by the total signal s312C is different from the data indicated by the selection signals s312A and s312B. The addition unit 312C transmits the generated total signal s312C to the hold unit 313. The hold unit 313 holds the total signal s312C received from the addition unit 312C. The hold unit 313 transmits the held total signal s312C to the signal processor 324 and the determining unit 601 as a hold signal s313C.

In the fifth embodiment, the hold unit 313B is tested using the test signal s322T generated by the test unit 322, and the hold unit 313A is tested using the conversion test signal s322T′ generated by the converter 319. For example, it is assumed that each of the hold units 313A and 313B holds three bits and the test signal s322T indicates “000”. In this case, the conversion test signal s322T′ indicates “111”. As a result, the sum of the test signal s322T and the conversion test signal s322T′ indicates “111”. If the hold unit 313C holds the sum value “111” during the test operation, a common value is held in the hold unit 313A and the hold unit 313C. On the other hand, for example, if there is a failure such as an electrical short circuit in the hold unit 313A and the hold unit 313C, a common value can be always held in the hold unit 313A and the hold unit 313C. That is, if common data is transmitted between the hold unit 313A or the hold units 313B and 313C, a failure such as a short circuit between the hold unit 313A or the hold unit 313B and the hold unit 313C cannot be detected. In order to detect a failure caused by a short circuit or the like, it is necessary to transmit different test signals to the hold units 313A, 313B, and 313C.

According to the present embodiment, as in the fifth embodiment, the test signal s322T is input to the pixel unit 310a and the pixel unit 310b. On the other hand, the total signal s312C as a test signal is generated based on the test signal s322T and the conversion test signal s322T′ via the pixel unit 310a, the pixel unit 310b, the converter 350, the OR circuit 351, and the addition unit 312C. The generated test signal (total signal s312C) is held in the hold unit 313C. The total signal s312C, which is the generated test signal, has a value different from that of the test signal s322T held in the hold unit 313B and the conversion test signal s322T′ held in the hold unit 313A. Therefore, even if there is a problem such as a short circuit between the hold unit 313A or 313B and the hold unit 313C, it is possible to detect a failure generated between the hold unit 313A or 313B and the hold unit 313C based on the test signal s322T, the conversion test signal s322T′, and the hold signal s313C.

The OR circuit 351 according to the present embodiment generates the total signal s351 by adding the conversion signal s350 and the selection signal s312A. As a modification of the present embodiment, the OR circuit 351 may generate the total signal s351 by adding the conversion signal s350 and the selection signal s312B. In this case, the addition unit 312C adds the total signal s351 and the selection signal s312A to generate the total signal s312C as a test signal.

### Eighth Embodiment

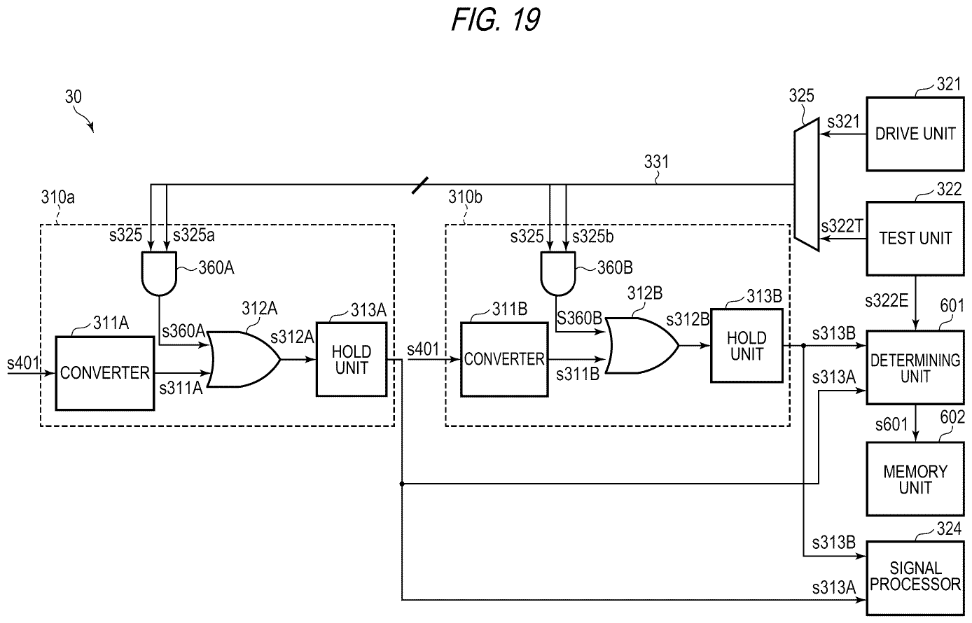

A semiconductor device according to an eighth embodiment of the present disclosure will be described with reference to FIG. 19, focusing on differences from the fifth embodiment.

FIG. 19 is a block diagram showing a flow of signals in the signal processing substrate 30 according to the present embodiment. The semiconductor device according to the present embodiment differs from the fifth embodiment in that the pixel unit 310a includes a controller 360A instead of the converter 319, and the pixel unit 310b further includes a controller 360B.

As illustrated in FIG. 19, the pixel unit 310a according to the present exemplary embodiment includes a controller 360A. In addition, the pixel unit 310b according to the present exemplary embodiment includes a controller 360B. Each of the controller 360A and the controller 360B includes an AND circuit. During the test operation, the controller 360A receives the test signal s322T and a control signal s325a as the selection signal s325 from the selection unit 325. The control signal s325a may be a one-bit (1 bit) signal. The controller 360A generates the selection signal s360A based on the selection signal s325 and the control signal s325a. The controller 360A transmits the generated selection signal s360A to the selection unit 312A. Specifically, if the control signal s325a indicates “1”, the controller 360A transmits the test signal s322T to the selection unit 312A. On the other hand, if the control signal s325a indicates “0”, the controller 360A does not transmit the test signal s322T to the selection unit 312A. Similarly, during the test operation, the controller 360B receives the test signal s322T and a control signal s325b as the selection signal s325 from the selection unit 325. The control signal s325b may be a one-bit (1 bit) signal. The controller 360B generates the selection signal s360B based on the selection signal s325 and the control signal s325b. The controller 360B transmits the generated selection signal s360B to the selection unit 312B. Specifically, if the control signal s325b indicates “1”, the controller 360B transmits the test signal s322T to the selection unit 312B. On the other hand, if the control signal s325b indicates “0”, the controller 360B does not transmit the test signal s322T to the selection unit 312B.

According to the present embodiment, the time at which the test signal s322T is held in the hold unit 313A and the time at which the test signal s322T is held in the hold unit 313B can be controlled. For example, at time t1 (first time), the selection unit 325 transmits the control signal s325a indicating “1” to the controller 360A, and transmits the control signal s325b indicating “0” to the controller 360B. Next, at time t2 (second time) after time t1, the selection unit 325 transmits the control signal s325a indicating “0” to the controller 360A, and transmits the control signal s325b indicating “1” to the controller 360B. In this case, at time t1, the test signal s322T is stored in the hold unit 313A. On the other hand, at time t1, the test signal s322T is not stored in the hold unit 313B. Then, at time t2, the test signal s322T is stored in the hold unit 313B. On the other hand, at time t2, the test signal s322T is not stored in the hold unit 313A. At time t3 different from times t1 and t2, the selection unit 325 inputs the control signal s325a indicating “1” and the control signal s325b indicating “1” to the controllers 360A and 360B, respectively. In this case, at time t3, the test signal s322T is simultaneously held in the hold unit 313A and the hold unit 313B. That is, according to the present embodiment, the test signal s322T can be selectively held in the hold unit 313A and the hold unit 313B using the control signals s325a and s325b.

### Ninth Embodiment

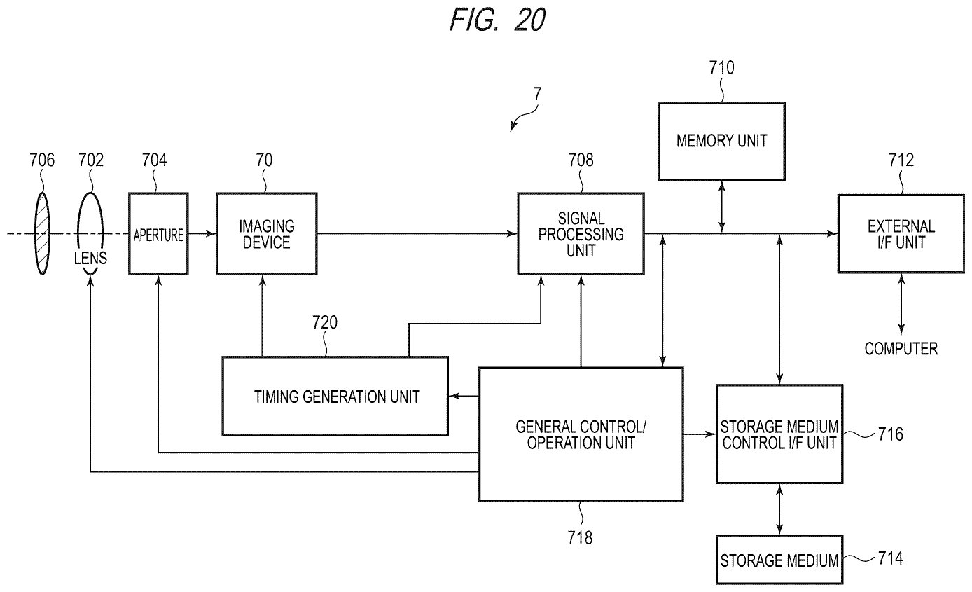

An imaging system according to the ninth embodiment of the present disclosure will be described with reference to FIG. 20. FIG. 20 is a block diagram of an imaging system according to the present embodiment. The photoelectric conversion device in the above-described embodiments can be applied to various imaging systems. Examples of the imaging system include a digital still camera, a digital camcorder, a camera head, a copier, a fax machine, a cellular phone, an in-vehicle camera, an observation satellite, and a surveillance camera. FIG. 20 is a block diagram of a digital still camera as an example of an imaging system.

An imaging system 7 illustrated in FIG. 20 includes a barrier 706, a lens 702, an aperture 704, an imaging device 70, a signal processing unit 708, a timing generation unit 720, a general control/operation unit 718, a memory unit 710, a storage medium control I/F unit 716, a storage medium 714, and an external I/F unit 712. The barrier 706 protects the lens, and the lens 702 forms an optical image of an object on the imaging device 70. The aperture 704 varies the amount of light passing through the lens 702. The imaging device 70 is configured like the photoelectric conversion device of the above embodiments, and converts an optical image formed by the lens 702 into image data. The signal processing unit 708 performs a process such as compression and various corrections of data on the imaging data output from the imaging device 70.

The timing generation unit 720 outputs various timing signals to the imaging device 70 and the signal processing unit 708. The general control/operation unit 718 controls the overall digital still camera, and the memory unit 710 temporarily stores image data. The storage medium control I/F unit 716 is an interface for recording or reading image data in or from the storage medium 714, and the storage medium 714 is a removable storage medium such as a semiconductor memory for recording or reading image data. The external I/F unit 712 is an interface for communicating with an external computer or the like. The timing signal or the like may be input from the outside of the imaging system 7, and the imaging system 7 may include at least the imaging device 70 and the signal processing unit 708 that processes the image signal output from the imaging device 70.

In the present embodiment, the imaging device 70 and the signal processing unit 708 are formed on different semiconductor substrates. However, the imaging device 70 and the signal processing unit 708 may be formed on the same semiconductor substrate.

Each pixel of the imaging device 70 may include a first photoelectric converter and a second photoelectric converter. The signal processing unit 708 may process the pixel signal based on the charge generated in the first photoelectric converter and the pixel signal based on the charge generated in the second photoelectric converter, and acquire the distance information from the imaging device 70 to the object.

### Tenth Embodiment

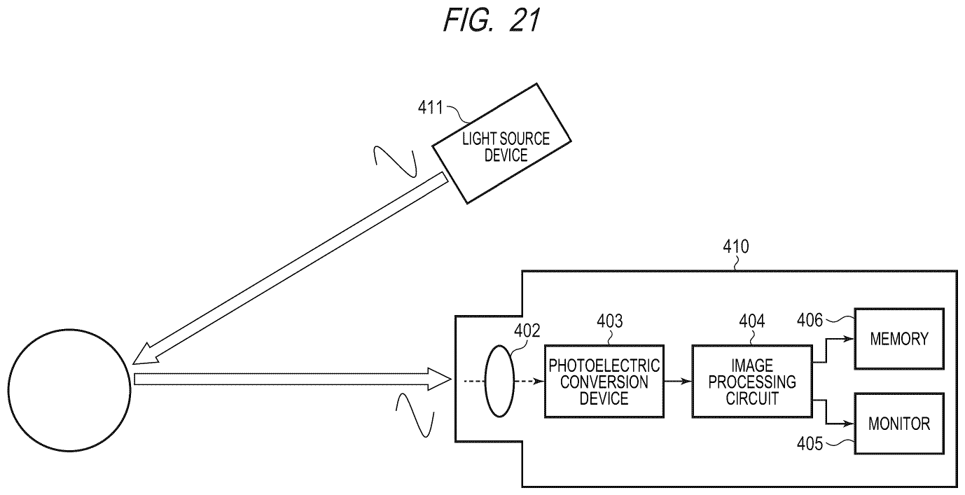

FIG. 21 is a block diagram of a photodetection system according to the present embodiment. More specifically, FIG. 21 is a block diagram of a ranging image sensor using the photoelectric conversion device according to the above-described embodiments.

As illustrated in FIG. 21, a ranging image sensor 410 includes an optical system 402, a photoelectric conversion device 403, an image processing circuit 404, a monitor 405, and a memory 406. The ranging image sensor 410 receives light (modulated light, pulsed light) emitted from a light source device 411 toward an object and reflected by the surface of the object. The ranging image sensor 410 can acquire a distance image corresponding to the distance to the object based on the time from light emission to light reception.

The optical system 402 includes one or multiple lenses, guides image light (incident light) from the object to the photoelectric conversion device 403, and forms an image on a light receiving surface (sensor portion) of the photoelectric conversion device 403.

As the photoelectric conversion device 403, the photoelectric conversion device of each of the above embodiments can be applied. The photoelectric conversion device 403 supplies a distance signal indicating a distance obtained from the received light signal to the image processing circuit 404.

The image processing circuit 404 performs image processing for forming a distance image based on the distance signal supplied from the photoelectric conversion device 403. The distance image (image data) obtained by image processing can be displayed on the monitor 405 and stored (recorded) in the memory 406.

By applying the photoelectric conversion device described above to the ranging image sensor 410 configured as described above, a more accurate distance image can be acquired.

### Eleventh Embodiment

The technology according to the present disclosure can be applied to various products. For example, techniques according to the present disclosure may be applied to an endoscope surgery system that is an example of the photodetection system.

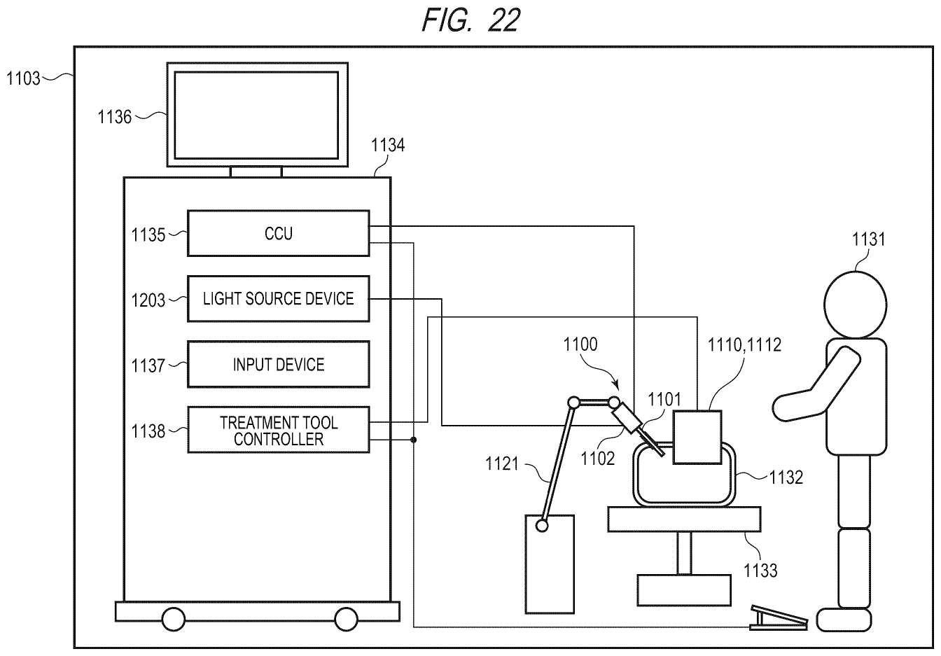

FIG. 22 is a schematic view of an endoscope surgery system according to the present embodiment. FIG. 22 shows a state in which an operator (physician) 1131 performs surgery on a patient 1132 on a patient bed 1133 using an endoscope surgery system 1103. As shown, the endoscope surgery system 1103 includes an endoscope 1100, a surgery tool 1110, and a cart 1134 on which various devices for endoscopic surgery are mounted.

The endoscope 1100 includes a lens barrel 1101 in which an area of a predetermined length from the distal end is inserted into the body cavity of the patient 1132, a camera head 1102 connected to the proximal end of the lens barrel 1101, and an arm 1121. Although FIG. 22 illustrates the endoscope 1100 configured as a so-called rigid scope having the rigid lens barrel 1101, the endoscope 1100 may be configured as a so-called flexible scope having a flexible lens barrel.

An opening into which an objective lens is fitted is provided at a distal end of the lens barrel 1101. A light source device 1203 is connected to the endoscope 1100. Light generated by the light source device 1203 is guided to the distal end of the barrel by a light guide extended inside the lens barrel 1101, and is irradiated toward an observation target in the body cavity of the patient 1132 via an objective lens. The endoscope 1100 may be a straight-viewing scope an oblique-viewing scope, or a side-viewing scope.

An optical system and a photoelectric conversion device are provided inside the camera head 1102, and reflected light (observation light) from an observation target is focused on the photoelectric conversion device by the optical system. The observation light is photoelectrically converted by the photoelectric conversion device, and an electric signal corresponding to the observation light, that is, an image signal corresponding to the observation image is generated. As the photoelectric conversion device, the photoelectric conversion device described in each of the above embodiments can be used. The image signal is transmitted to a camera control unit (CCU) 1135 as RAW data.

The CCU 1135 includes a central processing unit (CPU), a graphics processing unit (GPU), and the like, and controls overall operations of the endoscope 1100 and a display device 1136. Further, the CCU 1135 receives an image signal from the camera head 1102, and performs various kinds of image processing for displaying an image based on the image signal, such as development processing (demosaic processing).

The display device 1136 displays an image based on the image signal subjected to the image processing by the CCU 1135 under the control of the CCU 1135.

The light source device 1203 includes, for example, a light source such as a light emitting diode (LED), and supplies irradiation light to the endoscope 1100 when capturing an image of an operating part or the like.

An input device 1137 is an input interface to the endoscope surgery system 1103. The user can input various types of information and input instructions to the endoscope surgery system 1103 via the input device 1137.

A treatment tool controller 1138 controls the actuation of an energy treatment tool 1112 for ablation of tissue, incision, sealing of blood vessels, etc.

The light source device 1203 is capable of supplying irradiation light to the endoscope 1100 when capturing an image of the surgical site, and may be, for example, a white light source formed by an LED, a laser light source, or a combination thereof. When a white light source is configured by a combination of RGB laser light sources, the output intensity and output timing of each color (each wavelength) can be controlled with high accuracy. Therefore, the white balance of the captured image can be adjusted in the light source device 1203. In this case, laser light from each of the RGB laser light sources may be irradiated onto the observation target in a time-division manner, and driving of the image pickup device of the camera head 1102 may be controlled in synchronization with the irradiation timing. Thus, images corresponding to R, G, and B can be captured in a time-division manner. According to this method, a color image can be obtained without providing a color filter in the image pickup device.

The driving of the light source device 1203 may be controlled such that the intensity of light output from the light source device 1203 is changed at predetermined time intervals. By controlling the driving of the image pickup device of the camera head 1102 in synchronization with the timing of changing the intensity of light to acquire an image in a time-division manner, and by synthesizing the images, it is possible to generate an image in a high dynamic range without so-called blackout and whiteout.

Further, the light source device 1203 may be configured to be able to supply light in a predetermined wavelength band corresponding to special light observation. In special light observation, for example, the wavelength dependence of light absorption in body tissue can be used. Specifically, a predetermined tissue such as a blood vessel in the surface layer of the mucosa is imaged with high contrast by irradiating light in a narrow band compared to the irradiation light (i.e., white light) during normal observation. Alternatively, in special light observation, fluorescence observation for obtaining an image by fluorescence generated by irradiation with excitation light may be performed. In the fluorescence observation, excitation light can be irradiated to the body tissue to observe fluorescence from the body tissue, or a reagent such as indocyanine green (ICG) can be locally injected into the body tissue and the body tissue can be irradiated with excitation light corresponding to the fluorescence wavelength of the reagent to obtain a fluorescence image. The light source device 1203 may be configured to be able to supply narrowband light and/or excitation light corresponding to such special light observation.

### Twelfth Embodiment

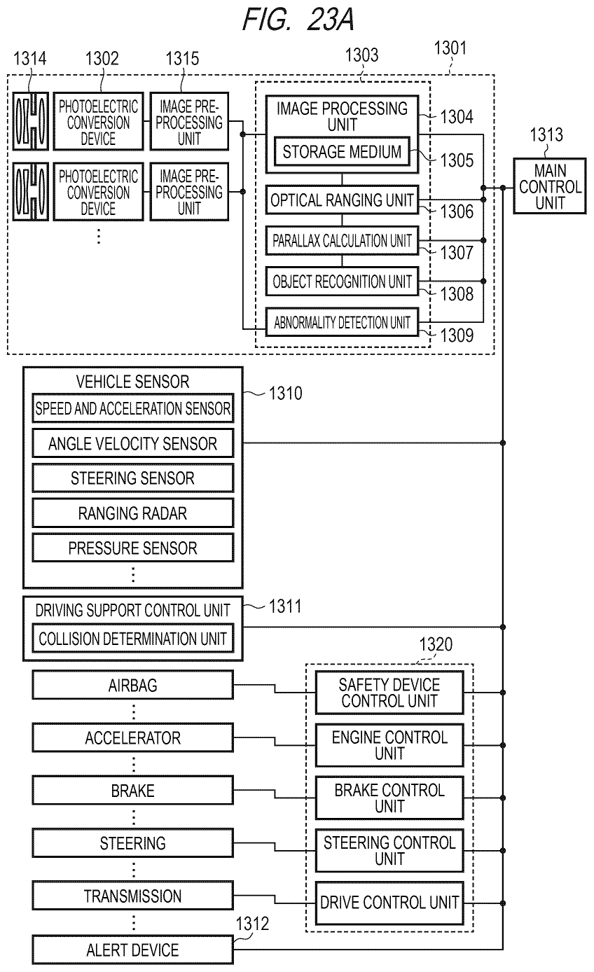

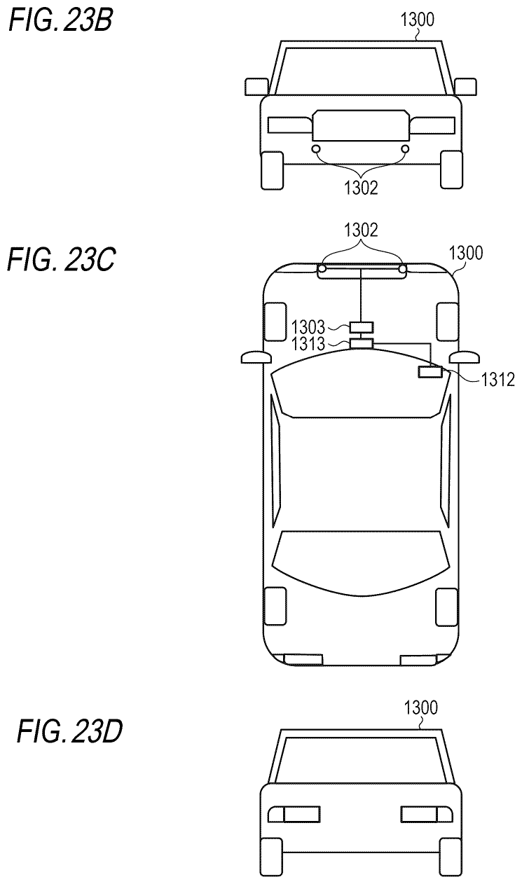

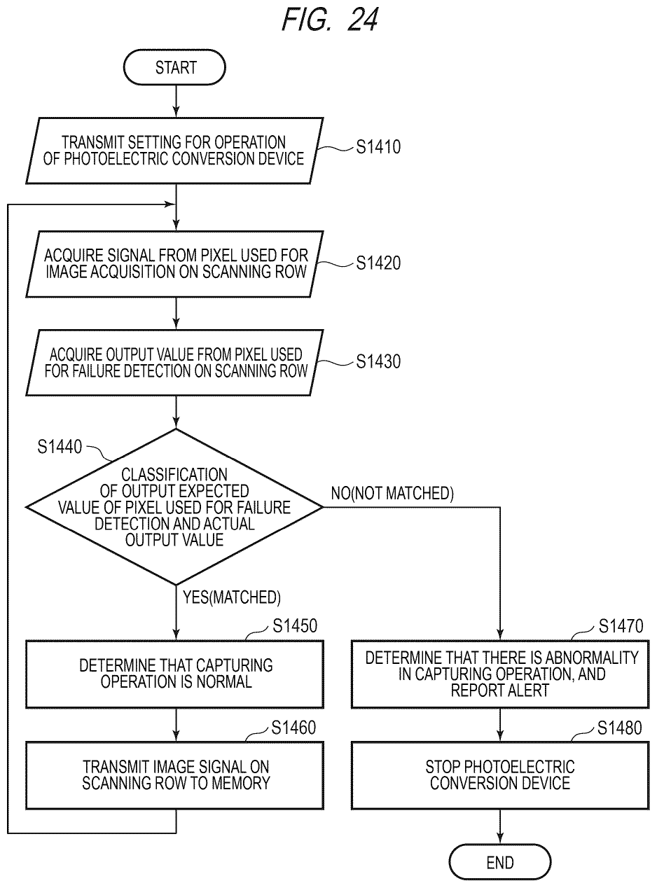

A light detection system and A movable body of the present embodiment will be described with reference to FIGS. 23A, 23B, 23C, 23D, and 24. In the present embodiment, an example of an in-vehicle camera is illustrated as a light detection system.

FIG. 23A is a schematic diagram of a light detection system according to the present embodiment, and illustrates an example of a vehicle system and a light detection system mounted on the vehicle system. A light detection system 1301 includes photoelectric conversion devices 1302, image pre-processing units 1315, an integrated circuit 1303, and optical systems 1314. The optical system 1314 forms an optical image of an object on the photoelectric conversion device 1302. The photoelectric conversion device 1302 converts the optical image of the object formed by the optical system 1314 into an electric signal. The photoelectric conversion device 1302 is the photoelectric conversion device of any one of the above-described embodiments. The image pre-processing unit 1315 performs predetermined signal processing on the signal output from the photoelectric conversion device 1302. The function of the image pre-processing unit 1315 may be incorporated in the photoelectric conversion device 1302. The light detection system 1301 is provided with at least two sets of the optical system 1314, the photoelectric conversion device 1302, and the image pre-processing unit 1315, and an output signal from the image pre-processing units 1315 of each set is input to the integrated circuit 1303.

The integrated circuit 1303 is an integrated circuit for use in an imaging system, and includes an image processing unit 1304 including a storage medium 1305, an optical ranging unit 1306, a parallax calculation unit 1307, an object recognition unit 1308, and an abnormality detection unit 1309. The image processing unit 1304 performs image processing such as development processing and defect correction on the output signal of the image pre-processing unit 1315. The storage medium 1305 performs primary storage of captured images and stores defect positions of image capturing pixels. The optical ranging unit 1306 focuses or measures the object. The parallax calculation unit 1307 calculates distance measurement information from the multiple pieces of image data acquired by the multiple photoelectric conversion devices 1302. The object recognition unit 1308 recognizes an object such as a car, a road, a sign, or a person. When the abnormality detection unit 1309 detects the abnormality of the photoelectric conversion device 1302, the abnormality detection unit 1309 issues an abnormality to a main control unit 1313.

The integrated circuit 1303 may be realized by dedicated hardware, a software module, or a combination thereof. It may be realized by a field programmable gate array (FPGA), an application specific integrated circuit (ASIC), or the like, or may be realized by a combination of these.

The main control unit 1313 (movable body controller) controls overall operations of the light detection system 1301, a vehicle sensor 1310, a control unit 1320, and the like. Without the main control unit 1313, the light detection system 1301, the vehicle sensor 1310, and the control unit 1320 may individually have a communication interface, and each of them may transmit and receive control signals via a communication network, for example, according to the CAN standard.

The integrated circuit 1303 has a function of transmitting a control signal or a setting value to the photoelectric conversion device 1302 by receiving a control signal from the main control unit 1313 or by its own control unit.

The light detection system 1301 is connected to the vehicle sensor 1310, and can detect a traveling state of the host vehicle such as a vehicle speed, a yaw rate, a steering angle, and the like, an environment outside the host vehicle, and states of other vehicles and obstacles. The vehicle sensor 1310 is also a distance information acquisition unit that acquires distance information to the object. The light detection system 1301 is connected to a driving support control unit 1311 that performs various driving support functions such as an automatic steering function, an automatic cruise function, and a collision prevention function. In particular, with regard to the collision determination function, based on detection results of the light detection system 1301 and the vehicle sensor 1310, it is determined whether or not there is a possibility or occurrence of collision with another vehicle or an obstacle. Thus, avoidance control is performed when a possibility of collision is estimated and a safety device is activated when collision occurs.

The light detection system 1301 is also connected to an alert device 1312 that issues an alarm to a driver based on a determination result of the collision determination unit. For example, when the possibility of collision is high as the determination result of the collision determination unit, the main control unit 1313 performs vehicle control such as braking, returning an accelerator, suppressing engine output, or the like, thereby avoiding collision or reducing damage. The alert device 1312 issues a warning to a user using means such as an alarm of a sound or the like, a display of alarm information on a display unit screen such as a car navigation system and a meter panel, and a vibration application to a seatbelt and a steering wheel.

The light detection system 1301 according to the present embodiment can capture an image around the vehicle, for example, the front or the rear. FIGS. 23B, 23C, and 23D are schematic diagrams of a movable body according to the present embodiment, and illustrate a configuration in which an image of the front of the vehicle is captured by the light detection system 1301.

The two photoelectric conversion devices 1302 are arranged in front of a vehicle 1300. Specifically, a center line with respect to a forward/backward direction or an outer shape (for example, a vehicle width) of the vehicle 1300 may be regarded as a symmetry axis, and the two photoelectric conversion devices 1302 may be arranged in line symmetry with respect to the symmetry axis. This makes it possible to effectively acquire distance information between the vehicle 1300 and the object to be imaged and determine the possibility of collision. Further, the photoelectric conversion device 1302 may be arranged at a position where it does not obstruct the field of view of the driver when the driver sees a situation outside the vehicle 1300 from the driver's seat. The alert device 1312 may be arranged at a position that is easy to enter the field of view of the driver.

Next, a failure detection operation of the photoelectric conversion device 1302 in the light detection system 1301 will be described with reference to FIG. 24. FIG. 24 is a flowchart illustrating an operation of the light detection system according to the present embodiment. The failure detection operation of the photoelectric conversion device 1302 may be performed according to steps S1410 to S1480 illustrated in FIG. 24.

In step S1410, the setting at the time of startup of the photoelectric conversion device 1302 is performed. That is, setting information for the operation of the photoelectric conversion device 1302 is transmitted from the outside of the light detection system 1301 (for example, the main control unit 1313) or the inside of the light detection system 1301, and the photoelectric conversion device 1302 starts an imaging operation and a failure detection operation.

Next, in step S1420, the photoelectric conversion device 1302 acquires pixel signals from the effective pixels. In step S1430, the photoelectric conversion device 1302 acquires an output value from a failure detection pixel provided for failure detection. The failure detection pixel includes a photoelectric conversion element in the same manner as the effective pixel. A predetermined voltage is written to the photoelectric conversion element. The failure detection pixel outputs a signal corresponding to the voltage written in the photoelectric conversion element. Steps S1420 and S1430 may be executed in reverse order.

Next, in step S1440, the light detection system 1301 performs a determination of correspondence between the expected output value of the failure detection pixel and the actual output value from the failure detection pixel. If it is determined in step S1440 that the expected output value matches the actual output value, the light detection system 1301 proceeds with the process to step S1450, determines that the imaging operation is normally performed, and proceeds with the process to step S1460. In step S1460, the light detection system 1301 transmits the pixel signals of the scanning row to the storage medium 1305 and temporarily stores them. Thereafter, the process of the light detection system 1301 returns to step S1420 to continue the failure detection operation. On the other hand, as a result of the determination in step S1440, if the expected output value does not match the actual output value, the light detection system 1301 proceeds with the process to step S1470. In step S1470, the light detection system 1301 determines that there is an abnormality in the imaging operation, and issues an alert to the main control unit 1313 or the alert device 1312. The alert device 1312 causes the display unit to display that an abnormality has been detected. Then, in step S1480, the light detection system 1301 stops the photoelectric conversion device 1302 and ends the operation of the light detection system 1301.

Although the present embodiment exemplifies the example in which the flowchart is looped for each row, the flowchart may be looped for each plurality of rows, or the failure detection operation may be performed for each frame. The alert of step S1470 may be notified to the outside of the vehicle via a wireless network.

Further, in the present embodiment, the control in which the vehicle does not collide with another vehicle has been described, but the present embodiment is also applicable to a control in which the vehicle is automatically driven following another vehicle, a control in which the vehicle is automatically driven so as not to protrude from the lane, and the like. Further, the light detection system 1301 can be applied not only to a vehicle such as a host vehicle, but also to a movable body (movable apparatus) such as a ship, an aircraft, or an industrial robot. In addition, the present embodiment can be applied not only to a movable body but also to an apparatus utilizing object recognition such as an intelligent transport systems (ITS). The photoelectric conversion device of the present disclosure may be a configuration capable of further acquiring various types of information such as distance information.

### Thirteenth Embodiment

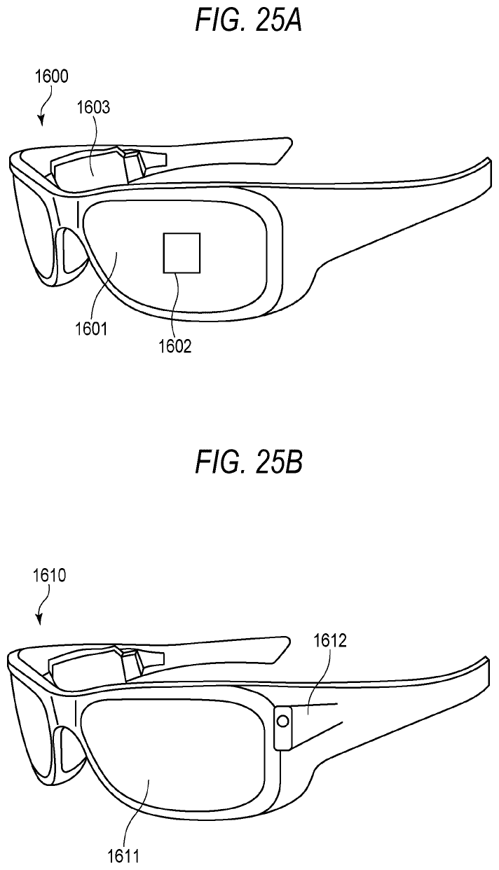

FIG. 25A is a diagram illustrating a specific example of an electronic device according to the present embodiment, and illustrates glasses 1600 (smart glasses). The glasses 1600 are provided with a photoelectric conversion device 1602 described in the above embodiments. That is, the glasses 1600 are an example of a light detection system to which the photoelectric conversion device 1602 described in each of the above embodiments can be applied. A display device including a light emitting device such as an OLED or an LED may be provided on the back surface side of a lens 1601. One photoelectric conversion device 1602 or the multiple photoelectric conversion devices 1602 may be provided. Further, multiple types of photoelectric conversion devices may be combined. The arrangement position of the photoelectric conversion device 1602 is not limited to that illustrated in FIG. 25A.

The glasses 1600 further comprise a control device 1603. The control device 1603 functions as a power source for supplying power to the photoelectric conversion device 1602 and the above-described display device. The control device 1603 controls operations of the photoelectric conversion device 1602 and the display device. The lens 1601 is provided with an optical system for collecting light to the photoelectric conversion device 1602.

FIG. 25B illustrates glasses 1610 (smart glasses) according to one application. The glasses 1610 include a control device 1612, and a photoelectric conversion device corresponding to the photoelectric conversion device 1602 and a display device are mounted on the control device 1612. A lens 1611 is provided with a photoelectric conversion device in the control device 1612 and an optical system for projecting light emitted from a display device, and an image is projected on the lens 1611. The control device 1612 functions as a power source for supplying power to the photoelectric conversion device and the display device, and controls operations of the photoelectric conversion device and the display device. The control device 1612 may include a line-of-sight detection unit that detects the line of sight of the wearer. Infrared radiation may be used to detect the line of sight. The infrared light emitting unit emits infrared light to the eyeball of the user who is watching the display image. The reflected light of the emitted infrared light from the eyeball is detected by an imaging unit having a light receiving element, whereby a captured image of the eyeball is obtained. A reduction unit that reduces light from the infrared light emitting unit to the display unit in a plan view may be employed and the reduction unit reduces a degradation in image quality.

The control device 1612 detects the line of sight of the user with respect to the display image from the captured image of the eyeball obtained by imaging the infrared light. Any known method can be applied to the line-of-sight detection using the captured image of the eyeball. As an example, a line-of-sight detection method based on a Purkinje image due to reflection of irradiation light at a cornea can be used.

More specifically, a line-of-sight detection process based on a pupil cornea reflection method is performed. By using the pupil cornea reflection method, a line-of-sight vector representing a direction (rotation angle) of the eyeball is calculated based on the image of the pupil included in the captured image of the eyeball and the Purkinje image, whereby the line-of-sight of the user is detected.

The display device of the present embodiment may include a photoelectric conversion device having a light receiving element, and may control a display image of the display device based on line-of-sight information of the user from the photoelectric conversion device.

Specifically, the display device determines a first view field region gazed by the user and a second view field region other than the first view field region based on the line-of-sight information. The first view field region and the second view field region may be determined by a control device of the display device, or may be determined by an external control device. In the display area of the display device, the display resolution of the first view field region may be controlled to be higher than the display resolution of the second view field region. That is, the resolution of the second view field region may be lower than that of the first view field region.

The display area may include a first display region and a second display region different from the first display region. A region having a high priority may be determined from the first display region and the second display region based on the line-of-sight information. The first view field region and the second view field region may be determined by a control device of the display device, or may be determined by an external control device. The resolution of the high priority area may be controlled to be higher than the resolution of the region other than the high priority region. That is, the resolution of a region having a relatively low priority can be reduced.

It should be noted that an artificial intelligence (AI) may be used in determining the first view field region and the region with high priority. The AI may be a model configured to estimate an angle of a line of sight and a distance to a target on the line-of-sight from an image of an eyeball, and the AI may be trained using training data including images of an eyeball and an angle at which the eyeball in the images actually gazes. The AI program may be provided in either a display device or a photoelectric conversion device, or may be provided in an external device. When the external device has the AI program, the AI program may be transmitted from a server or the like to a display device via communication.

In a case where the display control is performed based on the line-of-sight detection, the present embodiment can be applied to smart glasses which further includes a photoelectric conversion device for capturing an image of the outside. The smart glasses can display captured external information in real time.

### Other Embodiments

The present disclosure is not limited to the above embodiment, and various modifications are possible. For example, an example in which some of the configurations of any of the embodiments are added to other embodiments or an example in which some of the configurations of any of the embodiments are replaced with some of the configurations of other embodiments is also an embodiment of the present disclosure. As a modified example of each embodiment, a data storage circuit that temporarily stores the hold signal s313 can be arranged between the hold unit 313 and the signal processing unit 324.

In the twelfth embodiment, the failure detection pixel for detecting failure is used to detect failure of photoelectric conversion device (semiconductor device). On the other hand, according to the first to eleventh and thirteenth embodiments, failure of the hold unit included in the semiconductor device can be detected any time before shipped as a product, after shipped as a product, and while operating as a semiconductor device. For example, the test operation according to the present disclosure can be performed before the semiconductor devices are shipped as a product to exclude semiconductor devices that include hold units having failure from products to be shipped. Furthermore, the test operation for the hold unit according to each embodiment can be periodically performed while the semiconductor device is operating. In addition, a function of notifying the outside of a result of the test operation when detecting failure can be added to the semiconductor device of the present disclosure.

Each unit included in the semiconductor device according to the present disclosure can be a circuit device. For example, the pixel unit, the converter, the selection unit (selector), the switch unit, the hold unit, the drive unit, the test unit, the determining unit, and the peripheral units can be a pixel circuit, a converting circuit, a selecting circuit, a switch circuit, a hold circuit, a drive circuit, a test circuit, a determining circuit, and peripheral circuits, respectively.

According to the present disclosure, an increase in connecting lines in a pixel unit used for detecting failure of a counter included in a semiconductor device can be suppressed.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-231627, filed Dec. 27, 2024, and Japanese Patent Application No. 2025-160284, filed Sep. 26, 2025, which are hereby incorporated by reference herein in their entirety.

What is claimed is:

1. A semiconductor device comprising:
a pixel unit including a converter that converts a pixel signal into a conversion signal and a hold unit that holds the conversion signal;
a drive unit that generates a drive signal that indicates whether to cause the hold unit to hold the conversion signal; and
a test unit that generates a test signal used for testing the hold unit,
wherein, in a first operation mode, the drive unit outputs the drive signal to the pixel unit via a connecting line connected to the pixel unit, and the hold unit holds and outputs the conversion signal based on the drive signal, and
wherein, in a second operation mode, the test unit outputs the test signal to the pixel unit via the connecting line, and the hold unit holds and outputs the test signal.

2. The semiconductor device according to claim 1 further comprising:
a switch unit selectively connecting the connecting line to the drive unit or the test unit,
wherein, in the first operation mode, the switch unit connects the connecting line to the drive unit, and the hold unit holds the conversion signal based on the drive signal, and
wherein, in the second operation mode, the switch unit connects the connecting line to the test unit, and the hold unit holds the test signal based on the conversion signal.

3. The semiconductor device according to claim 2 further comprising a determining unit that determines a failure of the hold unit,
wherein the test unit outputs an expectation signal corresponding to the test signal to the determining unit, and
wherein, in the second operation mode, the determining unit compares the test signal output from the hold unit with the expectation signal to determine a failure of the hold unit.

4. The semiconductor device according to claim 1 further comprising a photoelectric conversion element that generates the pixel signal in response to incident light.

5. The semiconductor device according to claim 4, wherein, in the second operation mode, the pixel signal is fixed to a predetermined level.

6. The semiconductor device according to claim 5, wherein, in the second operation mode, charging the photoelectric conversion element is stopped.

7. The semiconductor device according to claim 5, wherein, in the second operation mode, the photoelectric conversion element is shielded from light.

8. The semiconductor device according to claim 4,
wherein the photoelectric conversion element includes an avalanche photodiode,
wherein the converter includes a gate circuit that converts the pixel signal into the conversion signal having a pulse form, and
wherein the hold unit includes a counter that counts the conversion signal.

9. The semiconductor device according to claim 2,
wherein the pixel units are arranged within a pixel area of a signal processing substrate in a matrix form, and
wherein the drive unit is arranged in an area of the signal processing substrate different from the pixel area.

10. The semiconductor device according to claim 9,
wherein the test unit includes a first test unit and a second test unit,
wherein the pixel unit includes a first pixel unit and a second pixel unit arranged to be adjacent to the first pixel unit, and
wherein, in the second operation mode, the first test unit outputs a first test signal to the first pixel unit, and the second test unit outputs a second test signal different from the first test signal to the second pixel unit.

11. The semiconductor device according to claim 10, wherein the hold unit comprises:
a first hold unit included in the first pixel unit;
a second hold unit included in the second pixel unit; and
a third hold unit that holds, in the first operation mode, a signal generated by adding the conversion signal output from the first pixel unit and the conversion signal output from the second pixel unit.

12. The semiconductor device according to claim 11,
wherein, in the second operation mode:
the first hold unit holds the first test signal;
the second hold unit holds the second test signal; and
the third hold unit holds a total test signal generated by adding the first test signal and the second test signal, and
wherein the first test signal, the second test signal, and the total test signal indicate data different from each other.

13. The semiconductor device according to claim 11,
wherein the test unit further includes a third test unit that outputs a third test signal,
wherein, in the second operation mode, the third hold unit holds a second total test signal generated by adding a first total test signal and the third test signal, and
wherein the first total test signal is generated by adding the first test signal and the second test signal.

14. The semiconductor device according to claim 9,
wherein the pixel unit includes a first pixel unit and a second pixel unit arranged to be adjacent to the first pixel unit,
wherein, in the second operation mode, the test unit outputs the test signal to the first pixel unit and the second pixel unit,
wherein the second pixel unit stores the test signal in the hold unit, and
wherein the first pixel unit inverts a polarity of the test signal to generate a first conversion test signal, and stores the first conversion test signal in the hold unit.

15. The semiconductor device according to claim 14, wherein the hold unit comprises:
a first hold unit included in the first pixel unit;
a second hold unit included in the second pixel unit; and
a third hold unit that holds a fourth total test signal generated by adding a third total test signal and the test signal output from the second pixel unit,
wherein the third total test signal is generated by adding a second conversion test signal and the first conversion test signal, the second conversion test signal being generated by converting at least a part of bits of the test signal.

16. The semiconductor device according to claim 9,
wherein the pixel unit includes a first pixel unit and a second pixel unit arranged to be adjacent to the first pixel unit,
wherein the hold unit comprises:
a first hold unit included in the first pixel unit; and
a second hold unit included in the second pixel unit, and
wherein the first hold unit stores the test signal at a first time, and the second hold unit stores the test signal at a second time that is different from the first time.

17. The semiconductor device according to claim 2,
wherein the pixel signal is an analog signal, and
wherein, in the first operation mode, the converter compares the pixel signal with a reference signal that changes over time, and outputs a clock signal as the conversion signal to the hold unit until a magnitude correlation between the reference signal and the pixel signal is reversed, and
wherein the hold unit counts the clock signal.

18. The semiconductor device according to claim 17 further comprising a photoelectric conversion element that generates the pixel signal in response to incident light,
wherein the photoelectric conversion element includes a photodiode.

19. An imaging system comprising:
an imaging device including the semiconductor device according to claim 1; and
a signal processing unit that processes image data output from the imaging device.

20. The imaging system according to claim 19, wherein the signal processing unit generates a distance image based on the image data, the distance image indicating distance information to an object.
